(19) United States
(12) Patent Application Publication
(10) Pub. No.: US 2009/0091413 A1
(43) Pub. Date: Apr. 9, 2009

(54) SIGNAL TRANSFER CIRCUIT

(75) Inventors: Yukio Kato, Kariya-shi (JP); Akiyuki Naito, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 12/245,081

(22) Filed: Oct. 3, 2008

(30) Foreign Application Priority Data
Oct. 3, 2007 (JP) 2007-260309

(51) Int. Cl. H01F 17/02

(52) U.S. Cl. 336/105

(57) ABSTRACT

A signal transfer circuit is configured by including a driving circuit for applying a voltage to a transformer depending on an input signal, a secondary side circuit for causing an output signal to rise when a voltage with a positive polarity is generated in the transformer, and for causing the output signal to fall when a voltage with a negative polarity is generated in the transformer, and a resistor for applying a voltage with a negative polarity with a level, by which the secondary side circuit does not operate, to the transformer after a voltage with a positive polarity is generated in the transformer, and for causing a voltage with a positive polarity with a level, by which the secondary side circuit does not operate, to be generated in the transformer after the voltage with the negative polarity is applied to the transformer.

### CROSS REFERENCE TO RELATED APPLICATION

This application claims priority to Japanese Patent Application No. 2007-260309 filed Oct. 3, 2007.

### TECHNICAL FIELD

The present invention relates to a signal transfer circuit for transferring a digital signal from an input side to an output side in a state where the input side and the output side are electrically insulated.

### BACKGROUND

A signal transfer circuit using a photo-coupler in a portion where input and output sides are electrically insulated exists as one type of signal transfer circuits.

However, this signal transfer circuit has a problem that a transmission delay of a digital signal becomes large because the photo-coupler has a large transmission delay between an input and an output. Additionally, this signal transfer circuit cannot be used under an environment of 100° C. or higher since the photo-coupler is unavailable under an environment of 100° C. or higher.

One solution to such problems is, for example, to use a transformer as a replacement for the photo-coupler in the portion where the input and the output sides are electrically insulated.

FIG. 1 shows a signal transfer circuit using a transformer as a portion where input and output sides are electrically insulated.

The signal transfer circuit 190 shown in FIG. 1 is configured by including a primary side circuit 191 to which a digital signal (input signal) is input, a secondary side circuit 192 for outputting a digital signal (output signal), and a transformer 193 for transferring a digital signal from the primary side circuit 191 to the secondary side circuit 192 by electrically insulating the primary side circuit 191 and the secondary side circuit 192.

The transformer 193 includes a primary side coil and a secondary side coil.

The primary side circuit 191 is configured by including power supply units 194 and 195, and a driving circuit 196.

The power supply units 194 and 195 are respectively configured by including an n-channel MOSFET (Metal Oxide Semiconductor Field Effect Transistor) 197, a p-channel MOSFET 198, and diodes 199 and 200.

The source terminal of the MOSFET 198 is connected to the power supply of a voltage VDD and the cathode terminal of the diode 199, whereas the drain terminal of the MOSFET 198 is connected to the drain terminal of the MOSFET 197, the anode terminal of the diode 199, and the cathode terminal of the diode 200. The source terminal of the MOSFET 197 and the anode terminal of the diode 200 are respectively connected to a ground. A connection point between the MOSFETs 197 and 198 in the power supply unit 194 is connected to one end of the primary side coil of the transformer 193, whereas a connection point between the MOSFETs 197 and 198 in the power supply unit 195 is connected to the other end of the primary side coil of the transformer 193.

Here, assume that one end (the point connected to the power supply unit 194) of the primary side coil of the transformer 193, and the other end (the point connected to the power supply unit 195) of the primary side coil of the transformer 193 are points A and B respectively.

The secondary side circuit 192 is configured by including a resistor 201, comparators (hysteresis comparators) 202 and 203, and a flip-flop circuit 204.

The positive input terminal of the comparator 202 is connected to one end of the secondary side coil of the transformer 193, one end of the resistor 201, and the negative input terminal of the comparator 203. The output terminal of the comparator 202 is connected to the set terminal (S) of the flip-flop circuit 204.

The positive input terminal of the comparator 203 is connected to the other end of the secondary side coil of the transformer 193, the other end of the resistor 201, and the negative input terminal of the comparator 202. The output terminal of the comparator 203 is connected to the reset terminal (R) of the flip-flop circuit 204.

Here, assume that one end (the point connected to the positive input terminal of the comparator 202) of the secondary side coil of the transformer 193, and the other end (the point connected to the positive input terminal of the comparator 203) of the secondary side coil of the transformer 193 are points C and D respectively.

FIG. 2 shows the driving circuit 196.

The driving circuit 196 shown in this figure is configured by including inverters 205 to 207, buffers 208 and 209, AND circuits 210 and 211, and rising delay circuits 212 and 213.

FIG. 3 is a timing chart showing the outputs of the circuits within the driving circuit 196.

An input signal at rising timing is input to one input terminal of the AND circuit 211 via the buffer 209, and at the same time, it is delayed by the rising delay circuit 213 by a predetermined time period, inverted by the inverter 207, and input to the other input terminal of the AND circuit 211. As a result, the AND circuit 211 outputs a high-level pulse voltage at the rising timing of the input signal. The high-level pulse voltage output from the AND circuit 211 at this time is input as a driving signal M1 to the gate terminals of the MOSFETs 197 and 198 of the power supply unit 195. Additionally, a low-level voltage output from the AND circuit 210 at this time is input as a driving signal M2 to the gate terminals of the MOSFETs 197 and 198 of the power supply unit 194.

Then, the MOSFET 198 of the power supply unit 194 and the MOSFET 197 of the power supply unit 195 are turned on, and the MOSFET 197 of the power supply unit 194 and the MOSFET 198 of the power supply unit 195 are turned off. As a result, the point B of the primary side circuit 191 is connected to the ground. Therefore, the voltage at the point B results in a low level (V=0), and the voltage at the point A in the primary side circuit 191 results in a high level (V=+VDD).

Accordingly, a pulse voltage with a positive polarity occurs between the points A and B of the primary side circuit 191, and a pulse voltage with a positive polarity occurs between the points C and D of the secondary side circuit 192 via the transformer 193. Then, a high-level pulse voltage output from the comparator 202 is input to the set terminal (S) of the flip-flop circuit 204. As a result, a voltage (output signal) output from the output terminal (Q) of the flip-flop circuit 204 increases.

In the meantime, the input signal at the falling timing is inverted by the inverter 205, and input to one input terminal of the AND circuit 210 via the buffer 208, and at the same time, it is inverted by the inverter 205, delayed by the rising delay circuit 212 by a predetermined time period, inverted by the inverter 206, and input to the other input terminal of the AND circuit 210. As a result, the AND circuit 210 outputs a high-level pulse voltage at the falling timing of the input signal. A high-level pulse voltage output from the AND circuit 210 is input as the driving signal M2 to the gate terminals of the MOSFETs 197 and 198 of the power supply unit 194. Additionally, a low-level voltage output from the AND circuit 211 is input as the driving signal M1 to the gate terminals of the MOSFETs 197 and 198 of the power supply unit 195. Then, the MOSFET 197 of the power supply unit 194 and the MOSFET 198 of the power supply unit 195 are turned on, and the MOSFET 198 of the power supply unit 194 and the MOSFET 197 of the power supply unit 195 are turned off. As a result, the point A of the primary side circuit 191 is connected to the ground. Therefore, the voltage at the point A results in a low level, and the voltage at the point B of the primary side circuit 191 results in a high level.

Accordingly, a pulse voltage with a negative polarity occurs between the points A and B of the primary side circuit 191, and a pulse voltage with a negative polarity occurs between the points C and D of the secondary side circuit 192 via the transformer 193. Then, a high-level pulse voltage output from the comparator 203 is input to the reset terminal (R) of the flip-flop circuit 204, and a voltage (output signal) output from the output terminal (Q) of the flip-flop circuit 204 decreases.

As described above, with the signal transfer circuit 190 shown in FIG. 1, the voltage output from the flip-flop circuit 204 increases at the rising timing of the input signal, and decreases at the falling timing of the input signal. Namely, the output signal, the rising and the falling timings of which are the same as those of the input signal input to the primary side circuit 191, is output from the secondary side circuit 192. With the signal transfer circuit 190 shown in FIG. 1, the input signal can be transferred from the primary side circuit 191 to the secondary side circuit 192 by electrically insulating the primary side circuit 191 and the secondary side circuit 192 with the transformer 193.

However, the signal transfer circuit 190 shown in FIG. 1 malfunctions if capacitive components are added to the points C and D of the secondary side circuit 192 and the coupling coefficient of the transformer 193 is low.

FIG. 4 is a timing chart showing the outputs of the circuits within the signal transfer circuit 190 when the signal transfer circuit 190 malfunctions.

When a high-level pulse voltage is respectively input to the gate terminals of the MOSFETs 197 and 198 of the power supply unit 195, and a low-level voltage is respectively input to the gate terminals of the MOSFETs 197 and 198 of the power supply unit 194 at the rising timing of the input signal, the voltage at the point A of the primary side circuit 191 results in a high level (V=+VDD), and the voltage at the point B results in a low level (V=0). Accordingly, a pulse voltage with a positive polarity occurs between the points A and B of the primary side circuit 61, and a pulse voltage with a positive polarity, which corresponds to the voltage with the positive polarity occurring between the points A and B, occurs between the points C and D of the secondary side circuit 192 via the transformer 193. If the coupling coefficient of the transformer 193 is low at this time, an LC oscillation circuit is formed with a leakage inductance of the transformer 193, and the capacitive components at the points C and D. This LC oscillation circuit oscillates, whereby the voltage between the points C and D results in a voltage with a negative polarity generated by the phenomenon that the voltage at the point C is higher than that at the point D. In such a case, a high-level pulse voltage is output from the comparator 203, and the output voltage of the flip-flop circuit 204 makes a transition from a high level to a low level. As a result, the input and the output signals do not match in some cases.

In the meantime, when a high-level pulse voltage is respectively input to the gate terminals of the MOSFETs 197 and 198 of the power supply unit 194, and a low-level voltage is input to the gate terminals of the MOSFETs 197 and 198 of the power supply unit 195 at the falling timing of the input signal, the voltage at the point A and that at the point B of the primary side circuit 191 result in a low level and a high level respectively as shown in FIG. 4. Accordingly, a pulse voltage with a negative polarity occurs between the points A and B of the primary side circuit 61, and a pulse voltage with a negative polarity, which corresponds to the voltage with the negative polarity occurring between the points A and B, occurs between the points C and D of the secondary side circuit 192 via the transformer 193. If the coupling coefficient of the transformer 193 is low at this time, an LC oscillation circuit is formed with the leakage inductance of the transformer 193, and capacitive components at the points C and D as described above. The LC oscillation circuit oscillates, whereby the voltage between the points C and D results in a voltage with a positive polarity generated by the phenomenon that the voltage at the point D is higher than that at the point C. In such a case, a high-level pulse voltage is output from the comparator 202, and the output voltage of the flip-flop circuit 204 makes a transition from a low level to a high level. As a result, the input and the output signals do no match in some cases.

As described above, the signal transfer circuit 190 shown in FIG. 1 can possibly malfunction if the coupling coefficient of the transformer 193 is low.

In the meantime, for example, Japanese Patent Publication No. SHO61-260744 discloses a signal transfer system for canceling out energy stored in a transformer by alternately applying pulse signals with positive and negative polarities to a primary side coil of the transformer during the high-level period of an input digital signal, as a signal transfer system for transferring a digital signal from a primary side to a secondary side via a transformer.

Therefore, applying this signal transfer system to the signal transfer circuit 190 is considered to prevent the oscillation in the secondary side circuit of the transformer 193 in the signal transfer circuit 190 shown in FIG. 1.

However, a high-level pulse voltage is output from the comparators 202 and 203 due to a pulse signal with a positive or negative polarity, which occurs in the secondary side coil of the transformer 193, at timings other than the rising and the falling timings of the input signal. This leads to a problem such that a digital signal the rising and the falling timings of which are different from those of the input digital signal is output from the secondary side circuit 192.

### SUMMARY

An object of the present invention is to provide a signal transfer circuit that can be prevented from malfunctioning even if the coupling coefficient of a transformer is low, when the transformer is used in a portion where input and output sides are electrically insulated.

The present invention adopts the following configurations in order to solve the above described problem.

Namely, the signal transfer circuit according to the present invention includes a transformer having a primary side coil and a secondary side coil, a plurality of switching elements provided between a power supply and a ground, a driving circuit for causing a voltage with a first polarity to be generated in the primary side coil by respectively controlling the plurality of switching elements at the rising timing of an input signal, and for causing a voltage with a second polarity opposite to the first polarity to be generated in the primary side coil by respectively controlling the plurality of switching elements at the falling timing of the input signal, and a secondary side circuit for causing an output signal to rise when the voltage with the first polarity, which is equal to or higher than a first threshold, is generated in the secondary side coil, and for causing the output signal to fall when the voltage with the second polarity, which is equal to or higher than a second threshold, is generated in the secondary side coil. In this signal transfer circuit, the driving circuit controls the plurality of switching elements so that a voltage for generating the voltage with the second polarity, which is lower than the second threshold, in the secondary side coil is generated in the primary side coil after the voltage with the first polarity, which is equal to or higher than the first threshold, is generated in the secondary side coil, and for controlling the plurality of switching elements so that a voltage for generating the voltage with the first polarity, which is lower than the first threshold, in the secondary side coil is generated in the primary side coil after the voltage with the second polarity, which is equal to or higher than the second threshold, is generated in the primary side coil.

With thus configured signal transfer circuit, energy stored in the primary side coil of the transformer can be reset even if the coupling coefficient of the transformer is low. As a result, oscillation in the secondary side circuit of the transformer can be prevented, whereby a malfunction can be suppressed.

According to the present invention, a signal transfer circuit using a transformer in a portion where input and output sides are electrically insulated can be prevented from malfunctioning even if the coupling coefficient of the transformer is low.

### BRIEF DESCRIPTION OF THE DRAWINGS

FIG. 1 shows a conventional signal transfer circuit;

FIG. 2 shows a driving circuit;

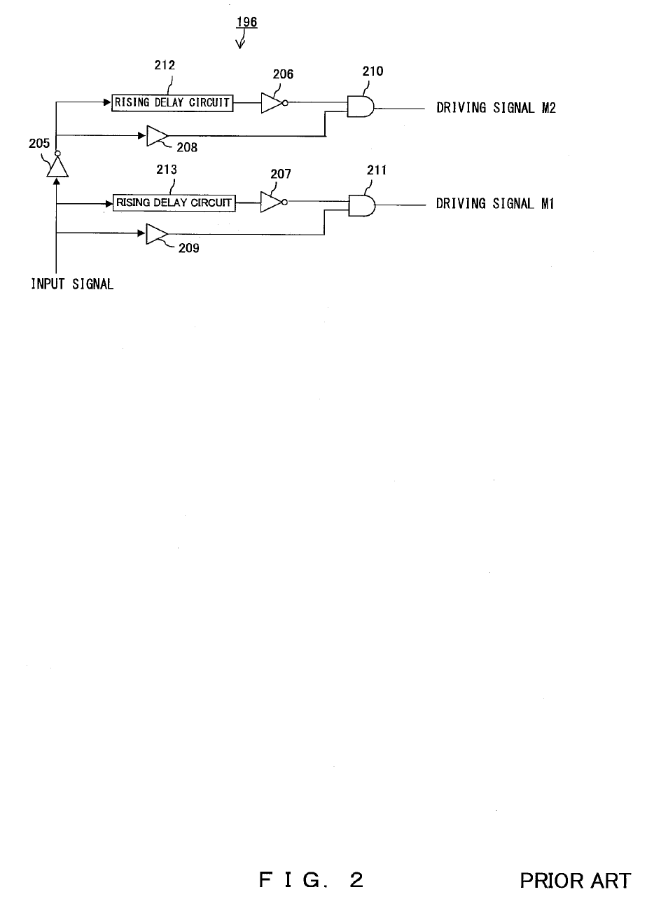

FIG. 3 is a timing chart showing the outputs of circuits within the driving circuit;

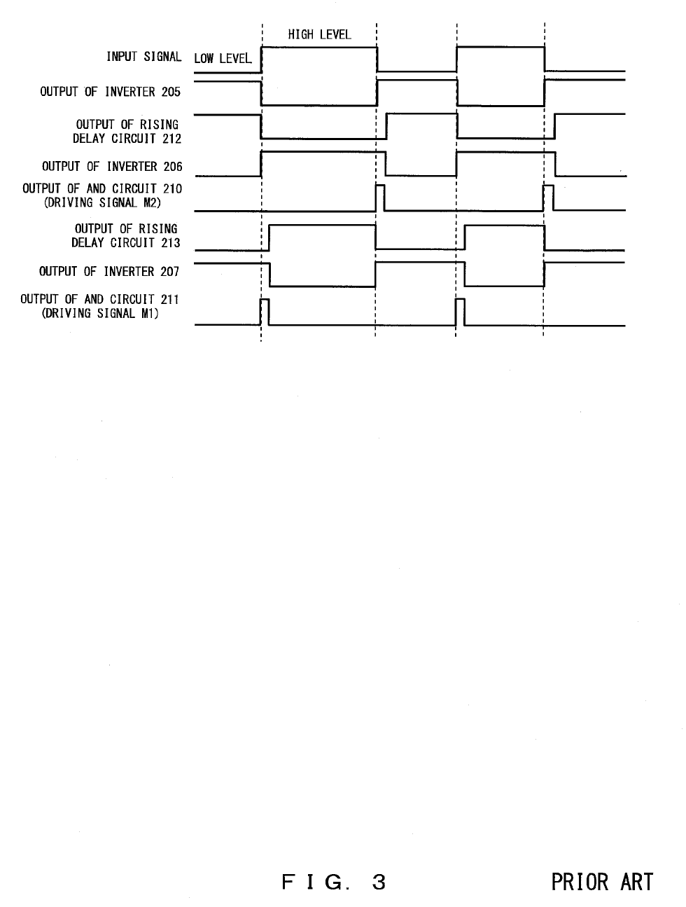

FIG. 4 is a timing chart showing the outputs of circuits within a conventional signal transfer circuit when the circuit malfunctions;

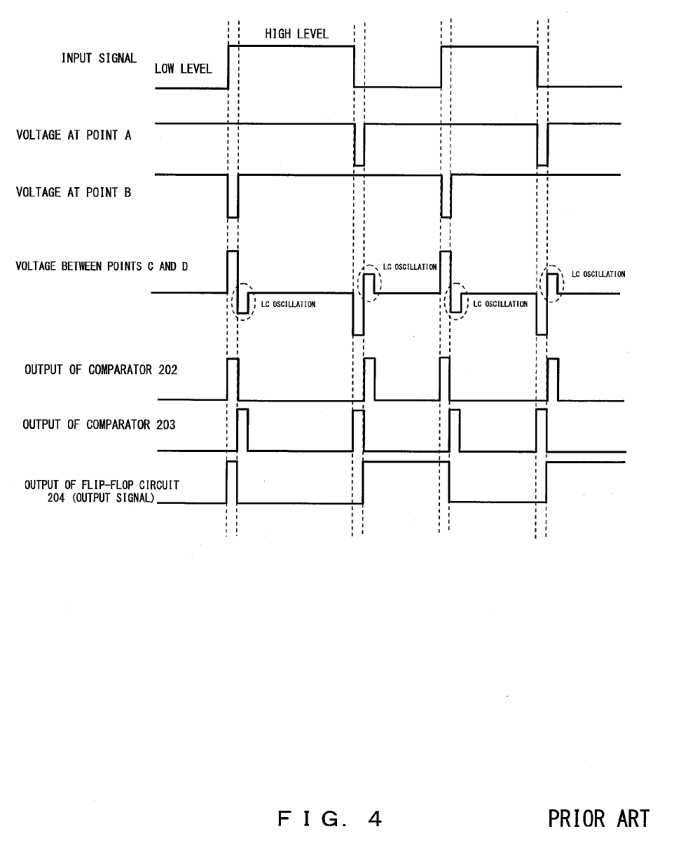

FIG. 5 shows a signal transfer circuit according to a first embodiment of the present invention;

FIG. 6 is a timing chart showing the outputs of circuits within the signal transfer circuit according to the first embodiment;

FIG. 7 shows a signal transfer circuit according to a second embodiment of the present invention;

FIG. 8 is a timing chart showing the outputs of circuits within the signal transfer circuit according to the second embodiment of the present invention;

FIG. 9 shows a signal transfer circuit according to a third embodiment of the present invention;

FIG. 10 is a timing chart showing the outputs of circuits within the signal transfer circuit according to the third embodiment of the present invention;

FIG. 11 shows a signal transfer circuit according to a fourth embodiment of the present invention;

FIG. 12 is a timing chart showing the outputs of circuits within the signal transfer circuit according to the fourth embodiment of the present invention;

FIG. 13 shows a signal transfer circuit according to a fifth embodiment of the present invention;

FIG. 14 shows a signal transfer circuit according to a sixth embodiment of the present invention;

FIG. 15 shows an abnormal signal output circuit;

FIG. 16 is a timing chart showing the outputs of circuits within the abnormal signal output circuit;

FIG. 17 is a timing chart showing the outputs of circuits within another implementation example of the signal transfer circuit shown in FIG. 11;

FIG. 18 shows a driving circuit;

FIG. 19 is a timing chart showing the outputs of circuits within the driving circuit;

FIG. 20 is a timing chart showing the outputs of circuits within the signal transfer circuit when the high-level period of an input signal is short;

FIG. 21 is a timing chart showing the outputs of circuits within the signal transfer circuit when the low-level period of an input signal is short;

FIG. 22 shows another configuration of power supply units in the signal transfer circuit shown in FIG. 11; and

FIG. 23 is a timing chart showing the outputs of circuits within the signal transfer circuit including the power supply units shown in FIG. 21.

### DETAILED DESCRIPTION OF ILLUSTRATIVE EMBODIMENTS

Embodiments according to the present invention are described below with reference to the drawings.

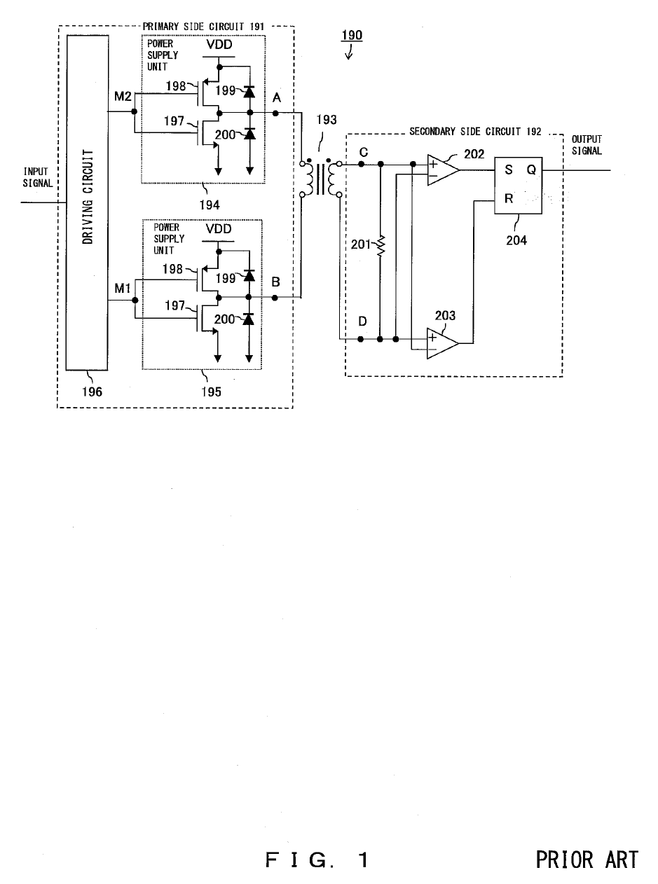

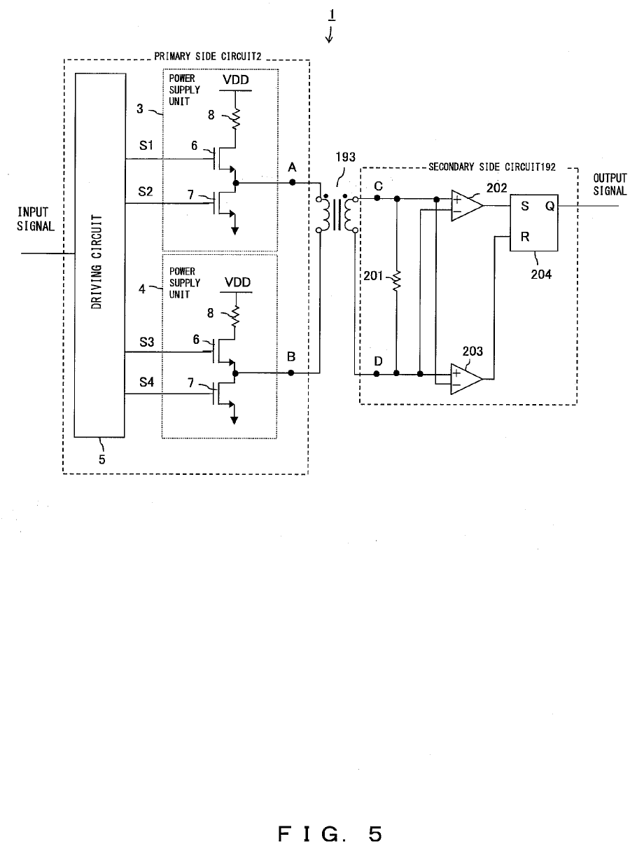

FIG. 5 shows a signal transfer circuit according to a first embodiment of the present invention. The same constituent elements as those of the signal transfer circuit 190 shown in FIG. 1 are denoted with the same reference numerals, and their explanations are omitted.

The signal transfer circuit 1 shown in FIG. 5 is configured by including a primary side circuit 2, a secondary side circuit 192, and a transformer 193.

The primary side circuit 2 is configured by including power supply units 3 and 4, and a driving circuit 5.

The power supply units 3 and 4 are respectively configured by including n-channel MOSFETs 6 and 7 (a plurality of switching elements) provided between a power supply of a voltage VDD and a ground, and a resistor 8 (voltage applying means) provided between the power supply and the MOSFET 6.

The drain terminal of the MOSFET 6 is connected to the power supply of the voltage VDD via the resistor 8, whereas the source terminal of the MOSFET 6 is connected to the drain terminal of the MOSFET 7. The source terminal of the MOSFET 7 is connected to the ground. A connection point between the MOSFETs 6 and 7 in the power supply unit 3 is connected to one end of a primary side coil of the transformer 193, whereas a connection point between the MOSFETs 6 and 7 in the power supply unit 4 is connected to the other end of the primary side coil of the transformer 193.

Here, assume that one end (the point connected to the power supply unit 3) of the primary side coil of the transformer 193, and the other end (the point connected to the power supply unit 4) of the primary side coil of the transformer 193 are points A and B respectively.

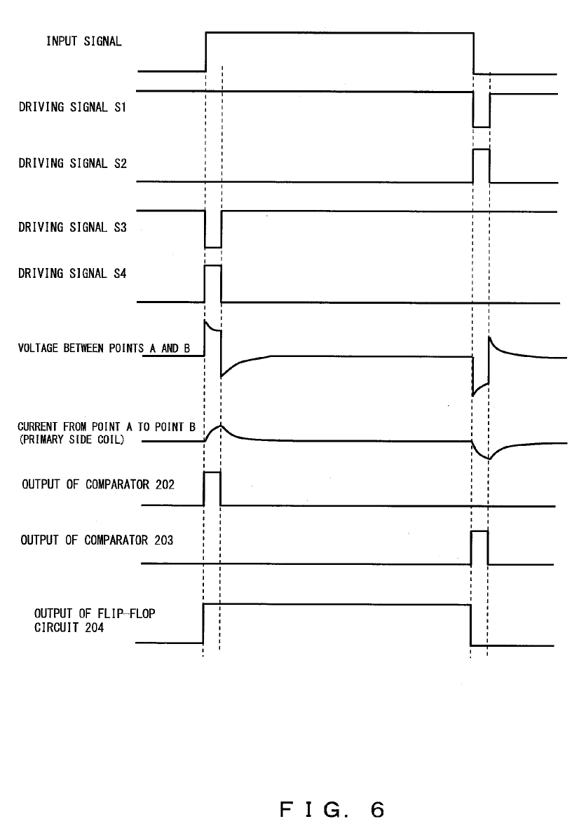

FIG. 6 is a timing chart showing the outputs of the circuits within the signal transfer circuit 1 shown in FIG. 5. Assume that the value of a current flowing from the point A to the point B, the resistance value of the resistor 8 of the power supply unit 3, and the resistance value of the resistor 8 of the power supply unit 4 are L, R1, and R2 respectively. Also assume that the values of R1 and R2 are the same.

As shown in FIGS. 5 and 6, at the rising timing of an input signal, a driving signal S3 input from the driving circuit 5 to the gate terminal of the MOSFET 6 of the power supply unit 4 makes a transition from a high level to a low level, and a driving signal S4 input from the driving circuit 5 to the gate terminal of the MOSFET 7 of the power supply unit 4 makes a transition from a low level to a high level (at this time, a driving signal S I output from the driving circuit 5 to the gate terminal of the MOSFET 6 of the power supply unit 3 is high-level, and a driving signal S2 output from the driving circuit 5 to the gate terminal of the MOSFET 7 of the power supply unit 3 is low-level).

Then, the MOSFET 6 of the power supply unit 3 and the MOSFET 7 of the power supply unit 4 are turned on, and the MOSFET 7 of the power supply unit 3 and the MOSFET 6 of the power supply unit 4 are turned off. As a result, the voltage at the point A of the primary side circuit 2 results in a voltage (VDD−L×R1) that drops from the power supply voltage VDD by a voltage (L×R1) due to the resistor 8 of the power supply unit 3, and the point B of the primary side circuit 2 is connected to the ground. Accordingly, a voltage with a positive polarity (VDD−L×R1) occurs between the points A and B of the primary side circuit 2, and a voltage with a positive polarity (VDD−L×R1), which corresponds to the voltage with the positive polarity occurring between the points A and B, occurs between the points C and D of the secondary side circuit 192 via the transformer 193. The voltage with the positive polarity (VDD−L×R1) is a voltage equal to or higher than a threshold value (first threshold) set by a comparator 202. When the voltage with the positive polarity is input to the comparator 202, a high-level voltage is output from the comparator 202.

When the voltage with the positive polarity occurs between the points C and D, a high-level voltage is output from the comparator 202 to the set terminal (S) of the flip-flop circuit 204, and a voltage (output signal) output from the output terminal (Q) of the flip-flop circuit 204 increases.

In the meantime, at the falling timing of the input signal, the driving signal S1 makes a transition from a high level to a low level, and the driving signal S2 makes a transition from a low level to a high level (at this time, the driving signal S3 is high-level, and the driving signal 4 is low-level).

Then, the MOSFET 7 of the power supply unit 3 and the MOSFET 6 of the power supply unit 4 are turned on, and the MOSFET 6 of the power supply unit 3 and the MOSFET 7 of the power supply unit 4 are turned off. As a result, the point A of the primary side circuit 2 is connected to the ground, and the point B of the primary side circuit 2 results in a voltage (VDD−L×R2) that drops from the power supply voltage VDD by a voltage (L×R2) due to the resistor 8 of the power supply unit 4. Accordingly, a voltage with a negative polarity (−(VDD−L×R2)) occurs between the points A and B of the primary side circuit 2, and a voltage with a negative polarity (−(VDD−L×R2)), which corresponds to the voltage with the negative polarity occurring between the points A and B, occurs between the points C and D of the secondary side circuit 192 via the transformer 193. The voltage with the negative polarity (−(VDD−L×R2)) is a voltage equal to or higher than a threshold value (second threshold) set by the comparator 203. When the voltage with the negative polarity is input to the comparator 203, a high-level voltage is output from the comparator 203.

When the voltage with the negative polarity occurs between the points C and D, a high-level voltage is output from the comparator 203 to the reset terminal (R) of the flip-flop circuit 204, and the voltage output from the output terminal (Q) of the flip-flop circuit 204 decreases.

As described above, the signal transfer circuit 1 shown in FIG. 5 can output a signal the rising and the falling timings of which are the same as those of an input signal, via the transformer 193.

After the rising timing of the input signal, the driving signal S3 restores from the low level to the high level, and the driving signal S4 restores from the high level to the low level in the signal transfer circuit 1 according to this embodiment (at this time, the driving signal S1 is high-level, and the driving signal S2 is low-level).

Then, one end (the point A) of the primary side coil of the transformer 193 is connected to the power supply (VDD) of the power supply unit 3 via the MOSFET 6 of the power supply unit 3 and the resistor 8 of the power supply unit 3, whereas the other end (the point B) of the primary side coil is connected to the power supply (VDD) of the power supply unit 4 via the MOSFET 6 of the power supply unit 4 and the resistor 8 of the power supply unit 4. Therefore, a voltage with a negative polarity (−(L×(R2+R1)) occurs between the points A and B, and an electric current, which flows through the power supply (VDD) of the power supply unit 3, the resistor 8 of the power supply unit 3, the MOSFET 6 of the power supply unit 3, the primary side coil of the transformer 193, the MOSFET 7 of the power supply unit 4, and the ground of the power supply unit 4 in this order, flows through the power supply (VDD) of the power supply unit 3, the resistor 8 of the power supply unit 3, the MOSFET 6 of the power supply unit 3, the primary side coil of the transformer 193, the MOSFET 6 of the power supply unit 4, the resistor 8 of the power supply unit 4, and the power supply (VDD) of the power supply unit 4 in this order. Accordingly, energy stored in the primary side coil of the transformer 193 is consumed by the resistor 8 of the power supply unit 4, and the energy stored in the transformer 193 is reset. When the energy stored in the transformer 193 is reset, the electric current that flows through the primary side coil of the transformer 193 is reduced to 0. Therefore, the voltages at the points A and B result in VDD.

Here, assume that the voltage with the negative polarity (−(L×(R2+R1)), which occurs between the points A and B at this time, is a voltage with a level by which a high-level voltage is not output from the comparator 203. Namely, the voltage with the negative polarity (−(L×(R2+R1)) is assumed to be a voltage lower than the above described second threshold.

Additionally, after the falling timing of the input signal, the driving signal S1 restores from the low level to the high level, and the driving signal S2 restores from the high level to the low level (at this time, the driving signal S3 is high-level, and the driving signal S4 is low-level).

Then, one end (point A) of the primary side coil of the transformer 193 is connected to the power supply (VDD) of the power supply unit 3 via the MOSFET 6 of the power supply unit 3 and the resistor 8 of the power supply unit 3, whereas the other end (point B) of the primary side coil is connected to the power supply (VDD) of the power supply unit 4 via the MOSFET 6 of the power supply unit 4 and the resistor 8 of the power supply unit 4. Therefore, a voltage with a positive polarity (L×(R1+R2)) occurs between the points A and B, and an electric current, which flows through the power supply (VDD) of the power supply unit 4, the resistor 8 of the power supply unit 4, the MOSFET 6 of the power supply unit 4, the primary side coil of the transformer 193, the MOSFET 7 of the power supply unit 3, and the ground of the power supply unit 3 in this order, flows through the power supply (VDD) of the power supply unit 4, the resistor 8 of the power supply unit 4, the MOSFET 6 of the power supply unit 4, the primary side coil of the transformer 193, the MOSFET 6 of the power supply unit 3, the resistor 8 of the power supply unit 3, and the power supply (VDD) of the power supply unit 3 in this order. Accordingly, energy stored in the primary side coil of the transformer 193 is consumed by the resistor 8 of the power supply unit 3, and the energy stored in the transformer 193 is reset. When the energy stored in the transformer 193 is reset, the electric current that flows through the transformer 193 is reduced to 0. Therefore, the voltages at the points A and B result in VDD.

Here, assume that the voltage with the positive polarity (L×(R1+R2)), which occurs between the points A and B at this time, is a voltage with a level by which a high-level voltage is not output from the comparator 202. Namely, the voltage with the positive polarity (L×(R1+R2)) is assumed to be a voltage lower than the above described first threshold.

As described above, the signal transfer circuit 1 shown in FIG. 5 can reset the energy stored in the transformer 193 after the rising timing or the falling timing of an input signal even if the coupling coefficient of the transformer 193 is low. Therefore, oscillation in the secondary side circuit 192 of the transformer 193 can be prevented, whereby a malfunction can be suppressed.

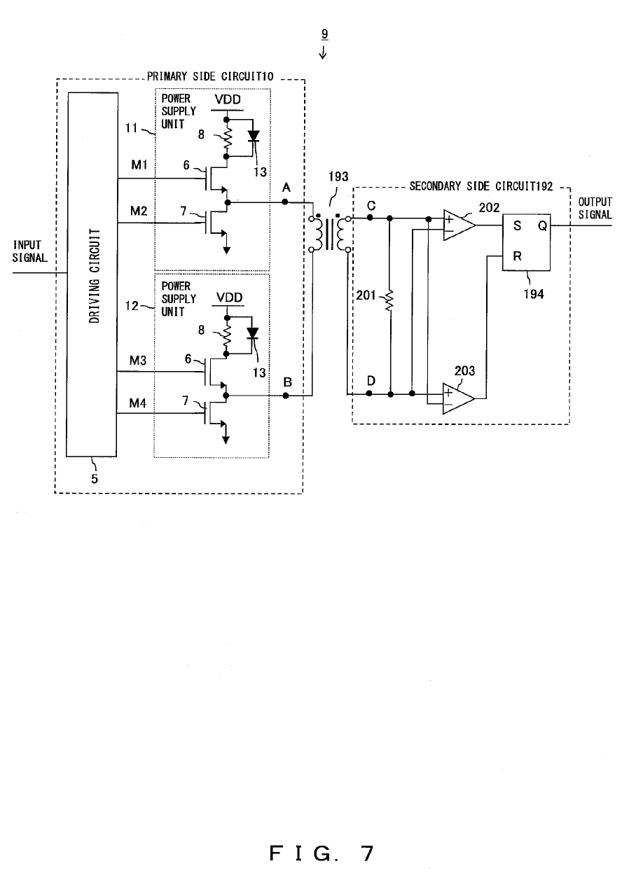

FIG. 7 shows a signal transfer circuit according to a second embodiment of the present invention. The same constituent elements as those of the signal transfer circuit 1 shown in FIG. 5 are denoted with the same reference numerals, and their explanations are omitted.

The signal transfer circuit 9 shown in FIG. 7 is configured by including a primary side circuit 10, a secondary side circuit 192, and a transformer 193.

The primary side circuit 10 is configured by including power supply units 11 and 12, and a driving circuit 5.

The power supply units 11 and 12 are respectively configured by including MOSFETs 6 and 7, a resistor 8, and a diode 13 (voltage applying means) connected in parallel to the resistor 8.

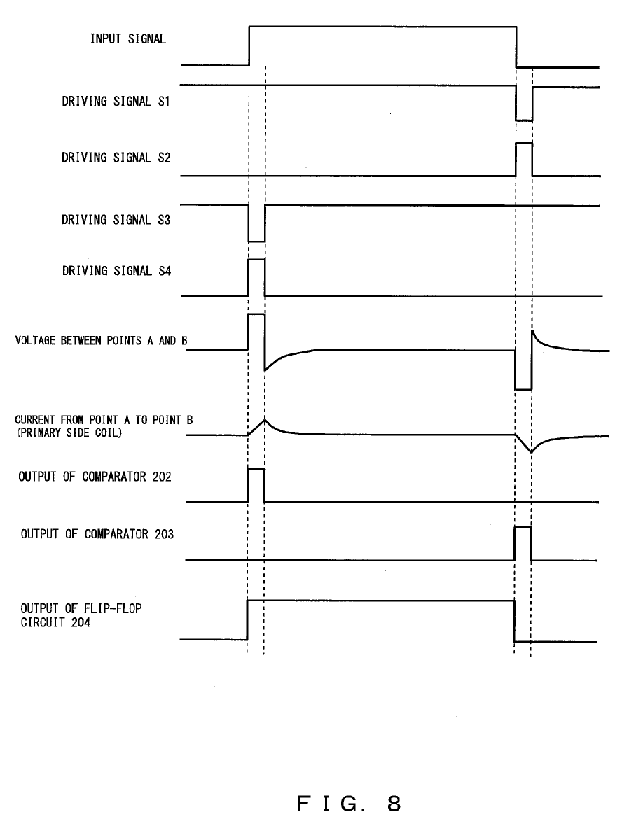

FIG. 8 is a timing chart showing the outputs of the circuits within the signal transfer circuit 9 shown in FIG. 7. Here, assume that the threshold voltage value of the diode 13 is VF1.

As shown in FIGS. 7 and 8, at the rising timing of an input signal, a driving signal S3 makes a transition from a high level to a low level, and a driving signal S4 makes a transition from a low level to a high level (at this time, a driving signal S1 is high-level, and a driving signal S2 is low-level).

Then, the MOSFET 6 of the power supply unit 11 and the MOSFET 7 of the power supply unit 12 are turned on, and the MOSFET 7 of the power supply unit 11 and the MOSFET 6 of the power supply unit 12 are turned off. As a result, a point A of the primary side circuit 2 results in a voltage (VDD−VF1) that drops from the power supply voltage VDD by a voltage VF1, and a point B of the primary side circuit 2 is connected to a ground. Accordingly, a voltage with a positive polarity (VDD−VF1) occurs between the points A and B of the primary side circuit 2, and a voltage with a positive polarity (VDD−VF1), which corresponds to the voltage with the positive polarity occurring between the points A and B, occurs between points C and D of the secondary side circuit 192 via the transformer 193.

When the voltage with the positive polarity occurs between the points C and D, a high-level voltage is output from the comparator 202 to the set terminal (S) of the flip-flop circuit 204, and a voltage (output signal) output from the output terminal (Q) of the flip-flop circuit 204 increases.

In the meantime, at the falling timing of the input signal, the driving signal S1 makes a transition from a high level to a low level, and the driving signal S2 makes a transition from a low level to a high level (at this time, the driving signal S3 is high-level, and the driving signal S4 is low-level).

Then, the MOSFET 7 of the power supply unit 11 and the MOSFET 6 of the power supply unit 12 are turned on, and the MOSFET 6 of the power supply unit 11 and the MOSFET 7 of the power supply unit 12 are turned off. As a result, the point A of the primary side circuit 2 is connected to the ground, and the point B of the primary side circuit 2 results in a voltage (VDD−VF1) that drops from the power supply voltage VDD by the voltage VF1. Accordingly, a voltage with a negative polarity (−(VDD−VF1)) occurs between the two points A and B of the primary side circuit 2, and a voltage with a negative polarity (−(VDD−VF1)), which corresponds to the voltage with the negative polarity occurring between the points A and B, occurs between the points C and D via the transformer 193.

When the voltage with the negative polarity occurs between the points C and D, a high-level voltage is output from the comparator 203 to the reset terminal (R) of the flip-flop circuit 204, and the voltage (output signal) output from the output terminal (Q) of the flip-flop circuit 204 decreases.

As described above, the signal transfer circuit 9 shown in FIG. 7 can output a signal, the rising and the falling timings of which are the same as those of an input signal, via the transformer 193.

After the rising timing of the input signal, the driving signal S3 restores from the low level to the high level, and the driving signal S4 restores from the high level to the low level (at this time, the driving signal S1 is high-level, and the driving signal S2 is low-level).

Then, one end (point A) of the primary side coil of the transformer 193 is connected to the power supply (VDD) of the power supply unit 11 via the MOSFET 6 of the power supply unit 11 and the diode 13 of the power supply unit 11, and the other end (point B) of the primary side coil of the transformer 193 is connected to the power supply (VDD) of the power supply unit 12 via the MOSFET 6 of the power supply unit 12 and the resistor 8 of the power supply unit 12. Therefore, a voltage with a negative polarity (−(L×R2+VF1)) occurs between the points A and B, and an electric current, which flows through the power supply (VDD) of the power supply unit 11, the diode 13 of the power supply unit 11, the MOSFET 6 of the power supply unit 11, the primary side coil of the transformer 193, the MOSFET 7 of the power supply unit 12, and the ground of the power supply unit 12 in this order, flows through the power supply (VDD) of the power supply unit 11, the diode 13 of the power supply unit 11, the MOSFET 6 of the power supply unit 11, the primary side coil of the transformer 193, the MOSFET 6 of the power supply unit 12, the resistor 8 of the power supply unit 12, and the power supply (VDD) of the power supply unit 12 in this order. Accordingly, energy stored in the primary side coil of the transformer 193 is consumed by the resistor 8 of the power supply unit 12, and the energy stored in the transformer 193 is reset. When the energy stored in the transformer 193 is reset, the electric current that flows through the primary side coil of the transformer 193 is reduced to 0, and the voltages at the points A and B result in VDD.

Here, assume that the voltage with the negative polarity (−(L×R2+VF1)), which occurs between the points A and B at this time, is a voltage with a level by which a high-level voltage is not output from the comparator 203. Namely, the voltage with the negative polarity (−(L×R2+VF1)) is assumed to be a voltage lower than the above described second threshold.

After the falling timing of the input signal, the driving signal S1 restores from the low level to the high level, and the driving signal S2 restores from the high level to the low level (at this time, the driving signal S3 is high-level, and the driving signal S4 is low-level).

Then, one end (point A) of the primary side coil of the transformer 193 is connected to the power supply (VDD) of the power supply unit 11 via the MOSFET 6 of the power supply unit 11 and the resistor 8 of the power supply unit 11, and the other end (point B) of the primary side coil is connected to the power supply (VDD) of the power supply unit 12 via the MOSFET 6 of the power supply unit 12 and the diode 13 of the power supply unit 12. Therefore, a voltage with a positive polarity (L×R1+VF1) occurs between the points A and B, and an electric current, which flows through the power supply (VDD) of the power supply unit 12, the diode 13 of the power supply unit 12, the MOSFET 6 of the power supply unit 12, the primary side coil of the transformer 193, the MOSFET 7 of the power supply unit 11, and the ground of the power supply unit 11 in this order, flows through the power supply (VDD) of the power supply unit 12, the diode 13 of the power supply unit 12, the MOSFET 6 of the power supply unit 12, the primary side coil of the transformer 193, the MOSFET 6 of the power supply unit 11, the resistor 8 of the power supply unit 11, and the power supply (VDD) of the power supply unit 11 in this order. Accordingly, energy stored in the primary side coil of the transformer 193 is consumed by the resistor 8 of the power supply unit 11, and the energy stored in the transformer 193 is reset at this time. When the energy stored in the transformer 193 is reset, the electric current that flows through the transformer 193 is reduced to 0, and the voltages at the points A and B result in VDD.

Assume that the voltage with the positive polarity (L×R1+VF1), which occurs between the points A and B at this time, is a voltage with a level by which a high-level voltage is not output from the comparator 202. Namely, the voltage with the positive polarity (L×R1+VF1) is assumed to be a voltage lower than the above described first threshold.

Accordingly, oscillation in the secondary side circuit of the transformer 193 can be prevented after the rising or the falling timing of an input signal in the signal transfer circuit 9 shown in FIG. 7 even if the coupling coefficient of the transformer 193 is low. Therefore, a malfunction can be suppressed.

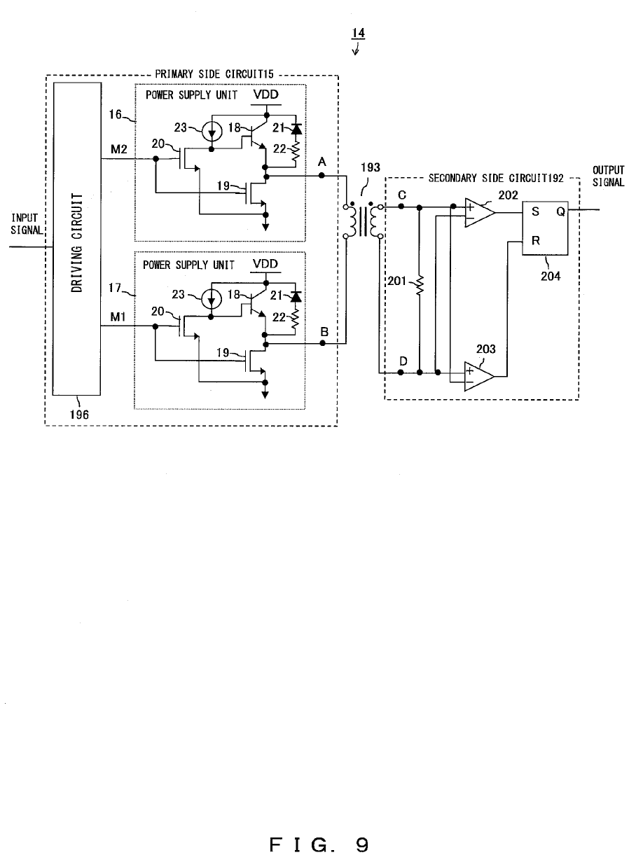

FIG. 9 shows a signal transfer circuit according to a third embodiment of the present invention. The same constituent elements as those of the signal transfer circuit 1 shown in FIG. 5 and the signal transfer circuit 190 shown in FIG. 1 are denoted with the same reference numerals, and their explanations are omitted.

The signal transfer circuit 14 shown in FIG. 9 is configured by including a primary side circuit 15, a secondary side circuit 192, and a transformer 193.

The primary side circuit 15 is configured by including power supply units 16 and 17, and a driving circuit 196.

The power supply units 16 and 17 are respectively configured by including an npn bipolar transistor 18 (voltage applying means), n-channel MOSFETs 19 and 20 (a plurality of switching elements), a diode 21 (voltage applying means), a resistor 22 (voltage applying means), and a constant-current source 23.

The collector terminal of the npn bipolar transistor 18 is connected to a power supply of a voltage VDD and the cathode terminal of the diode 21, and further connected to the drain terminal of the MOSFET 20 and the base terminal of the npn bipolar transistor 18 via the constant-current source 23, whereas the emitter terminal of the npn bipolar transistor 18 is connected to the drain terminal of the MOSFET 19, and further connected to the anode terminal of the diode 21 via the resistor 22. The gate terminals of the MOSFETs 19 and 20 are mutually connected, and the source terminals of the MOSFETs 19 and 20 are connected to a ground. A connection point between the npn bipolar transistor 18 and the MOSFET 19 in the power supply unit 16 is connected to one end of the primary side coil of the transformer 193, and a connection point between the npn bipolar transistor 18 and the MOSFET 19 in the power supply unit 17 is connected to the other end of the primary side coil of the transformer 193.

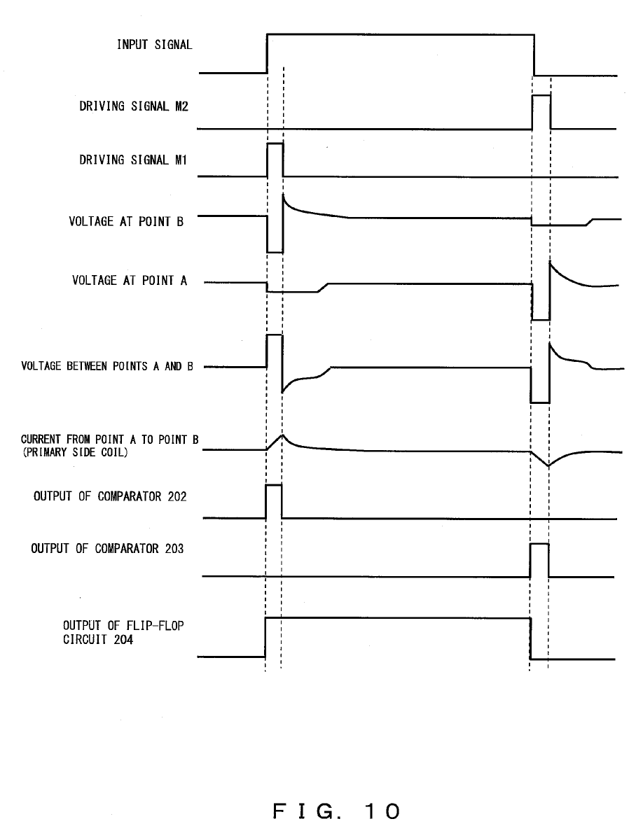

FIG. 10 is a timing chart showing the outputs of the circuits within the signal transfer circuit 14 shown in FIG. 9. Here, assume that the resistance value of the resistor 22 of the power supply unit 16, the resistance value of the resistor 22 of the power supply unit 17, a voltage between the base and the emitter of the npn bipolar transistor 18, and the threshold voltage of the diode 21 are R3, R4, Vbe, and VF2 respectively.

As shown in FIGS. 9 and 10, at the rising timing of the input signal, the driving signal M1 makes a transition from a low level to a high level (at this time, the driving signal M2 is low-level).

Then, the npn bipolar transistor 18 of the power supply unit 16 and the MOSFET 19 of the power supply unit 17 are turned on, and the MOSFET 19 of the power supply unit 16 and the npn bipolar transistor 18 of the power supply unit 17 are turned off. As a result, a point B of the primary side circuit 15 is connected to the ground, and a point A of the primary side circuit 15 results in a voltage (VDD−Vbe) that drops from the power supply voltage VDD by a voltage Vbe. Accordingly, a voltage with a positive polarity (VDD−Vbe) occurs between the points A and B of the primary side circuit 15, and a voltage with a positive polarity (VDD−Vbe), which corresponds to the voltage with the positive polarity occurring between the points A and B, occurs between points C and D of the secondary side circuit 192 via the transformer 193.

When the voltage with the positive polarity occurs between the points C and D, a high-level voltage is output from the comparator 202 to the set terminal (S) of the flip-flop circuit 204, and a voltage (output signal) output from the output terminal (Q) of the flip-flop circuit 204 increases.

In the meantime, at the falling timing of the input signal, the driving signal M2 makes a transition from a low level to a high level (at this time, the driving signal M1 is low-level).

Then, the MOSFET 19 of the power supply unit 16 and the npn bipolar transistor 18 of the power supply unit 17 are turned on, and the npn bipolar transistor 18 of the power supply unit 16 and the MOSFET 19 of the power supply unit 17 are turned off. As a result, the point A of the primary side circuit 15 is connected to the ground, and the point B of the primary side circuit 15 results in a voltage (VDD−Vbe) that drops from the power supply voltage VDD by the voltage Vbe. Accordingly, a voltage with a negative polarity (−(VDD−Vbe)) occurs between the two points A and B of the primary side circuit 15, and a voltage with a negative polarity (−(VDD−Vbe)), which corresponds to the voltage with the negative polarity occurring between the points A and B, occurs between the points C and D via the transformer 193.

When the voltage with the negative polarity occurs between the points C and D, a high-level voltage is output from the comparator 203 to the reset terminal (R) of the flip-flop circuit 204, and the voltage (output signal) output from the output terminal (Q) of the flip-flop circuit 204 decreases.

As described above, the signal transfer circuit 14 shown in FIG. 9 can output a signal, the rising and the falling timings of which are the same as those of an input signal, via the transformer 193.

After the rising timing of the input signal, the driving signal M1 restores from the high level to the low level.

Then, one end (point A) of the primary side coil of the transformer 193 is connected to the power supply (VDD) of the power supply unit 16 via the npn bipolar transistor 18 of the power supply unit 16, and the other end (point B) of the primary side coil is connected to the power supply (VDD) of the power supply unit 17 via the resistor 22 of the power supply unit 17 and the diode 21 of the power supply unit 17. Therefore, a voltage with a negative polarity (−(L×R4+VF2+Vbe)) occurs between the points A and B, and an electric current, which flows through the power supply (VDD) of the power supply unit 16, the npn bipolar transistor 18 of the power supply unit 16, the primary side coil of the transformer 193, the MOSFET 19 of the power supply unit 17, and the ground of the power supply unit 17 in this order, flows through the power supply (VDD) of the power supply unit 16, the npn bipolar transistor 18 of the power supply unit 16, the primary side coil of the transformer 193, the resistor 22 of the power supply unit 17, the diode 21 of the power supply unit 17, and the power supply (VDD) of the power supply unit 17 in this order. Accordingly, energy stored in the primary side coil of the transformer 193 is consumed by the diode 21 and the resistor 22 of the power supply unit 17, and the energy stored in the transformer 193 is reset. When the energy stored in the transformer 193 is reset, the electric current that flows through the transformer 193 is reduced to 0, and the voltages at the points A and B result in the power supply voltage VDD.

Here, assume that the voltage with the negative polarity (−(L×R4+VF2+Vbe)), which occurs between the points A and B at this time, is a voltage with a level by which a high-level voltage is not output from the comparator 203. Namely, the voltage with the negative polarity (−(L×R4+VF2+Vbe)) is assumed to be a voltage lower than the above described second threshold.

After the falling timing of the input signal, the driving signal M2 restores from the high level to the low level.

Then, one end (point A) of the primary side coil of the transformer 193 is connected to the power supply (VDD) of the power supply unit 16 via the resistor 22 of the power supply unit 16 and the diode 21 of the power supply unit 16, and the other end (point B) of the primary side coil is connected to the power supply (VDD) of the power supply unit 17 via the npn bipolar transistor 18 of the power supply unit 17. Therefore, a voltage with a positive polarity (L×R3+VF2+Vbe) occurs between the points A and B, and an electric current, which flows through the power supply (VDD) of the power supply unit 17, the npn bipolar transistor 18 of the power supply unit 17, the primary side coil of the transformer 193, the MOSFET 19 of the power supply unit 16, and the ground of the power supply unit 16 in this order, flows through the power supply (VDD) of the power supply unit 17, the npn bipolar transistor 18 of the power supply unit 17, the primary side coil of the transformer 193, the resistor 22 of the power supply unit 16, the diode 21 of the power supply unit 16, and the power supply (VDD) of the power supply unit 16 in this order. Accordingly, energy stored in the primary side coil of the transformer 193 is consumed by the diode 21 and the resistor 22 of the power supply unit 16, and the energy stored in the transformer 193 is reset. When the energy stored in the transformer 193 is reset, the electric current that flows through the transformer 193 is reduced to 0, and the voltages at the points A and B result in the power supply voltage VDD.

Here, assume that the voltage with the positive polarity (L×R3+VF2+Vbe), which occurs between the points A and B at the time, is a voltage with a level by which a high-level voltage is not output from the comparator 202. Namely, the voltage with the positive polarity (L×R3+VF2+Vbe) is assumed to be a voltage lower than the above described first threshold.

Accordingly, oscillation in the secondary side circuit 192 can be prevented after the rising or the falling timing of the input signal in the signal transfer circuit 14 shown in FIG. 9 even if the coupling coefficient of the transformer 193 is low. Therefore, a malfunction can be suppressed.

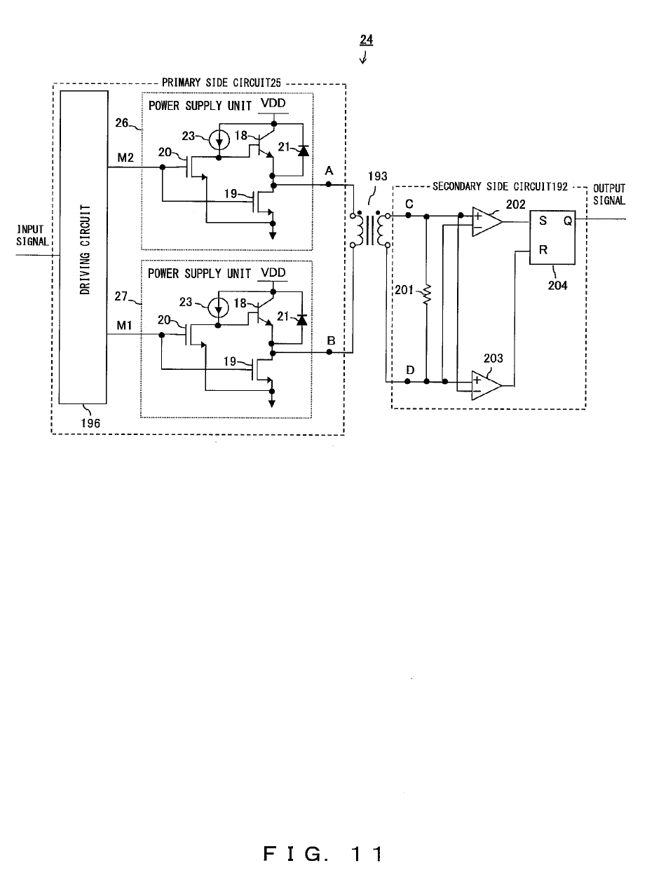

FIG. 11 shows a signal transfer circuit according to a fourth embodiment of the present invention. The same constituent elements as those of the signal transfer circuit 1 shown in FIG. 5 and the signal transfer circuit 14 shown in FIG. 9 are denoted with the same reference numerals, and their explanations are omitted.

The signal transfer circuit 24 shown in FIG. 11 is configured by including a primary side circuit 25, a secondary side circuit 192, and a transformer 193.

The primary side circuit 25 is configured by including power supply units 26 and 27, and a driving circuit 196.

The power supply units 26 and 27 are respectively configured by including an npn bipolar transistor 18, MOSFETs 19 and 20, a diode 21 (voltage applying means), and a constant-current source 23.

The collector terminal of the npn bipolar transistor 18 is connected to a power supply of a voltage VDD and the cathode terminal of the diode 21, and further connected to the drain terminal of the MOSFET 20 and the base terminal of the npn bipolar transistor 18 via the constant-current source 23, whereas the emitter terminal of the npn bipolar transistor 18 is connected to the drain terminal of the MOSFET 19 and the anode terminal of the diode 21. The gate terminals of the MOSFETs 19 and 20 are mutually connected, and the source terminals of the MOSFETs 19 and 20 are respectively connected to a ground. A connection point between the npn bipolar transistor 18 and the MOSFET 19 in the power supply unit 26 is connected to one end of the primary side coil of the transformer 193, whereas a connection point between the npn bipolar transistor 18 and the MOSFET 19 in the power supply unit 27 is connected to the other end of the primary side coil of the transformer 193.

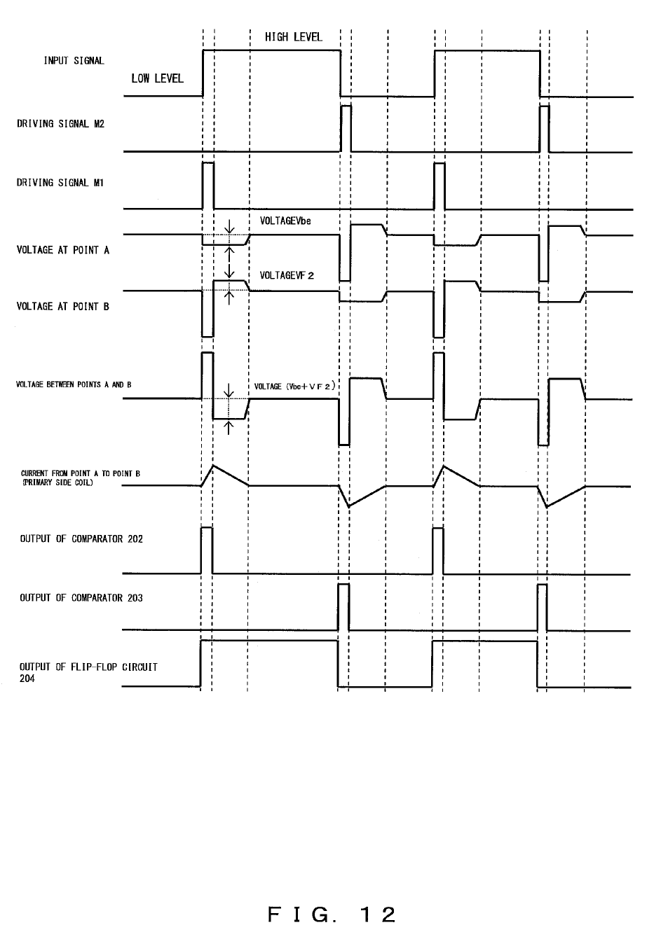

FIG. 12 is a timing chart showing the outputs of the circuits within the signal transfer circuit 24 shown in FIG. 11. Here, assume that the voltage between the base and the emitter of the npn bipolar transistor 18 is Vbe, and the threshold voltage of the diode 21 is VF2.

As shown in FIGS. 11 and 12, at the rising timing of an input signal, a driving signal M1 makes a transition from a low level to a high level (at this time, a driving signal M2 is low-level).

Then, the npn bipolar transistor 18 of the power supply unit 26 and the MOSFET 19 of the power supply unit 27 are turned on, and the MOSFET 19 of the power supply unit 26 and the npn bipolar transistor 18 of the power supply unit 27 are turned off. As a result, a point B of the primary side circuit 25 is connected to the ground, and a point A of the primary side circuit 25 results in a voltage (VDD−Vbe) that drops from the power supply voltage VDD by a voltage Vbe. Accordingly, a voltage with a positive polarity (VDD−Vbe) occurs between the points A and B of the primary side circuit 25, and a voltage with a positive polarity (VDD−Vbe), which corresponds to the voltage with the positive polarity occurring between the points A and B, occurs between points C and D of the secondary side circuit 192 via the transformer 193.

When the voltage with the positive polarity occurs between the points C and D, a high-level voltage is output from the comparator 202 to the set terminal (S) of the flip-flop circuit 204, and a voltage (output signal) output from the output terminal (Q) of the flip-flop circuit 204 increases.

In the meantime, at the falling timing of the input signal, the driving signal M2 makes a transition from a low level to a high level (at this time, the driving signal M1 is low-level).

Then, the MOSFET 19 of the power supply unit 26 and the npn bipolar transistor 18 of the power supply unit 27 are turned on, and the npn bipolar transistor 18 of the power supply unit 26 and the MOSFET 19 of the power supply unit 27 are turned off. As a result, the point A of the primary side circuit 25 is connected to the ground, and the point B of the primary side circuit 25 results in a voltage (VDD−Vbe) that drops from the power supply voltage VDD by the voltage Vbe. Accordingly, a voltage with a negative polarity (−(VDD−Vbe)) occurs between the points A and B of the primary side circuit 25, and a voltage with a negative polarity (−(VDD−Vbe)) occurs between the points C and D via the transformer 193.

When the voltage with the negative polarity occurs between the points C and D, a high-level voltage is output from the comparator 203 to the reset terminal (R) of the flip-flop circuit 204, and the voltage output from the output terminal (Q) of the flip-flop circuit 204 decreases.

Here, assume that the comparators 202 and 203 are set to output a high-level voltage when the voltage between the points C and D is a voltage between (VDD−Vbe) and (Vbe+VF2). However, (VDD−Vbe)>(Vbe+VF2) is assumed.

As described above, the signal transfer circuit 24 shown in FIG. 11 can output a signal, the rising and the falling timings of which are the same as those of an input signal, via the transformer 193.

After the rising timing of the input signal, the driving signal M1 restores from the high level to the low level in the signal transfer circuit 24 according to this embodiment.

Then, one end (point A) of the primary side coil of the transformer 193 is connected to the power supply (VDD) of the power supply unit 26 via the npn bipolar transistor 18 of the power supply unit 26, and the other end (point B) of the primary side coil is connected to the power supply (VDD) of the power supply unit 27 via the diode 21 of the power supply unit 27. Therefore, a voltage with a negative polarity (−(VF2+Vbe)) occurs between the points A and B, and an electric current, which flows through the power supply (VDD) of the power supply unit 26, the npn bipolar transistor 18 of the power supply unit 26, the primary side coil of the transformer 193, the MOSFET 19 of the power supply unit 27, and the ground of the power supply unit 27 in this order, flows through the power supply (VDD) of the power supply unit 26, the npn bipolar transistor 18 of the power supply unit 26, the primary side coil of the transformer 193, the diode 21 of the power supply unit 27, and the power supply (VDD) of the power supply unit 27 in this order. Accordingly, energy stored in the primary side coil of the transformer 193 is consumed by the diode 21 of the power supply unit 27, and the energy stored in the primary side coil of transformer 193 is reset. When the energy stored in the transformer 193 is reset, the electric current that flows through the transformer 193 is reduced to 0, and the voltages at the points A and B result in the power supply voltage VDD.

Here, assume that the voltage with the negative polarity (−(VF2+Vbe)), which occurs between the points A and B at the time, is a voltage with a level by which a high-level voltage is not output from the comparator 203. Namely, the voltage with the negative polarity (−(VF2+Vbe)) is assumed to be a voltage lower than the above described second threshold.

In the meantime, also after the falling timing of the input signal, the driving signal M2 restores from the high level to the low level in the signal transfer circuit 24 according to this embodiment.

Then, one end (point A) of the primary side coil of the transformer 193 is connected to the power supply (VDD) of the power supply unit 16 via the diode 21 of the power supply unit 26, and the other end (point B) of the primary side coil is connected to the power supply (VDD) of the power supply unit 27 via the npn bipolar transistor 18 of the power supply unit 27. Therefore, a voltage with a positive polarity (VF2+Vbe) occurs between the points A and B, and an electric current, which flows through the power supply (VDD) of the power supply unit 27, the npn bipolar transistor 18 of the power supply unit 27, the primary side coil of the transformer 193, the MOSFET 19 of the power supply unit 26, and the ground of the power supply unit 26 in this order, flows through the power supply (VDD) of the power supply unit 27, the npn bipolar transistor 18 of the power supply unit 27, the primary side coil of the transformer 193, the diode 21 of the power supply unit 26, and the power supply (VDD) of the power supply unit 26 in this order. Accordingly, energy stored in the primary side coil of the transformer 193 is consumed by the diode 21 of the power supply unit 26, and the energy stored in the transformer 193 is reset. When the energy stored in the transformer 193 is reset, the electric current that flows through the transformer 193 is reduced to 0, and the voltages at the points A and B result in the power supply voltage VDD.

Here, assume that the voltage with the positive polarity (VF2+Vbe), which occurs between the points A and B at this time, is a voltage with a level by which a high-level voltage is not output from the comparator 202. Namely, the voltage with the positive polarity (VF2+Vbe) is assumed to be a voltage lower than the above described first threshold.

Accordingly, oscillation in the secondary side circuit 192 can be prevented after the rising or the falling timing of an input signal in the signal transfer circuit 24 shown in FIG. 11 even if the coupling coefficient of the transformer 193 is low. Therefore, a malfunction can be suppressed.

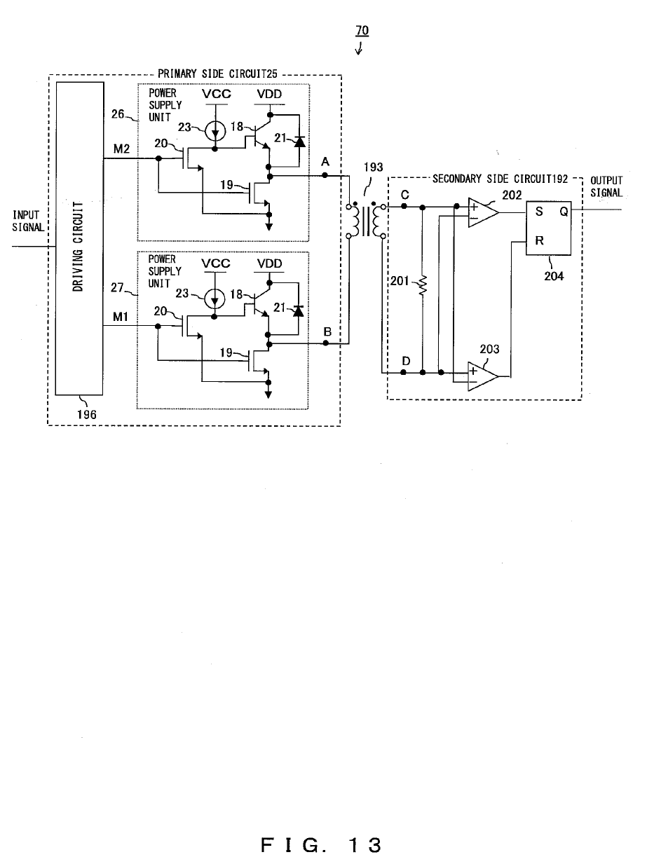

FIG. 13 shows a signal transfer circuit according to a fifth embodiment of the present invention. The same constituent elements as those of the signal transfer circuit 24 shown in FIG. 11 are denoted with the same reference numerals, and their explanations are omitted.

The signal transfer circuit 70 shown in FIG. 13 is different from the signal transfer circuit 24 shown in FIG. 11 in a point that the constant-current source 23 of the power supply units 26 and 27 is connected not to the power supply of a voltage VDD but to the power supply of a voltage VCC. Here, assume that the voltage VDD is higher than the voltage VCC, and the voltages VDD and VCC are, for example, 6V and 5V respectively.

Operations of the signal transfer circuit 70 shown in FIG. 13 are described. Assume that driving signals M1 and M2 output from a driving circuit 196 are the same as the driving signals M1 and M2 shown in FIG. 12.

At the rising timing of an input signal, the driving signal M1 makes a transition from a low level to a high level (at this time, the driving signal M2 is low-level).

Then, the npn bipolar transistor 18 of the power supply unit 26 and the MOSFET 19 of the power supply unit 27 are turned on, and the MOSFET 19 of the power supply unit 26 and the npn bipolar transistor 18 of the power supply unit 27 are turned off. As a result, a point B of a primary side circuit 25 is connected to a ground, and a point A of the primary side circuit 25 results in a voltage (VCC−Vbe) that drops from the power supply voltage VCC by a voltage Vbe. Accordingly, a voltage with a positive polarity (VCC−Vbe) occurs between the points A and B of the primary side circuit 25, and a voltage with a positive polarity (VCC−Vbe), which corresponds to the voltage with the positive polarity occurring between the points A and B, occurs between points C and D of a secondary side circuit 192 via a transformer 193.

When the voltage with the positive polarity occurs between the points C and D, a high-level voltage is output from a comparator 202 to the set terminal (S) of a flip-flop circuit 204, and a voltage (output signal) output from the output terminal (Q) of the flip-flop circuit 204 increases.

In the meantime, at the falling timing of the input signal, the driving signal M2 makes a transition from a low level to a high level (at this time, the driving signal M1 is low-level).

Then, the MOSFET 19 of the power supply unit 26 and the npn bipolar transistor 18 of the power supply unit 27 are turned on, and the npn bipolar transistor 18 of the power supply unit 26 and the MOSFET 19 of the power supply unit 27 are turned off. As a result, the point A of the primary side circuit 25 is connected to the ground, and the point B of the primary side circuit 25 results in a voltage (VCC−Vbe) that drops from the power supply voltage VCC by the voltage Vbe. Accordingly, a voltage with a negative polarity (−(VCC−Vbe)) occurs between the points A and B of the primary side circuit 25, and a voltage with a negative polarity (−(VCC−Vbe)) occurs between the points C and D via the transformer 193.

When the voltage with the negative polarity occurs between the points C and D, a high-level voltage is output from the comparator 203 to the reset terminal (R) of the flip-flop circuit 204, and the voltage output from the output terminal (Q) of the flip-flop circuit 204 decreases.

Here, assume (VCC−Vbe)>(VDD+VF2).

As described above, the signal transfer circuit 70 shown in FIG. 13 can output a signal, the rising and the falling timings of which are the same as those of an input signal, via the transformer 193.

After the rising timing of the input signal, the driving signal M1 restores from the high level to the low level in the signal transfer circuit 70 according to this embodiment.

Then, one end (point A) of the primary side coil of the transformer 193 is connected to the power supply (VDD) of the power supply unit 16 via the npn bipolar transistor 18 of the power supply unit 26, and the other end (point B) of the primary side coil is connected to the power supply (VDD) of the power supply unit 17 via the diode 21 of the power supply unit 27. As a result, a voltage with a negative polarity (−((VDD−VCC)+VF2+Vbe)) occurs between the points A and B, and an electric current, which flows through the power supply (VDD) of the power supply unit 26, the npn bipolar transistor 18 of the power supply unit 26, the primary side coil of the transformer 193, the MOSFET 19 of the power supply unit 27, and the ground of the power supply unit 27 in this order, flows through the power supply (VDD) of the power supply unit 26, the npn bipolar transistor 18 of the power supply unit 26, the primary side coil of the transformer 193, the diode 21 of the power supply unit 27, and the power supply (VDD) of the power supply unit 27 in this order. Accordingly, energy stored in the primary side coil of the transformer 193 is consumed by the diode 21 of the power supply unit 27, and the energy stored in the primary side coil of the transformer 193 is reset.

Here, assume that the voltage with the negative polarity (−((VDD−VCC)+VF2+Vbe)), which occurs between the points A and B at this time, is a voltage with a level by which a high-level voltage is not output from the comparator 203. Namely, the voltage with the negative polarity (−((VDD−VCC)+VF2+Vbe)) is assumed to be a voltage lower than the above described second threshold.

In the meantime, also after the falling timing of the input signal, the driving signal M2 restores from the high level to the low level in the signal transfer circuit 70 according to this embodiment.

Then, one end (point A) of the primary side coil of the transformer 193 is connected to the power supply (VDD) of the power supply unit 26 via the diode 21 of the power supply unit 26, and the other end (point B) of the primary side coil is connected to the power supply (VDD) of the power supply unit 27 via the npn bipolar transistor 18 of the power supply unit 27. As a result, a voltage with a positive polarity ((VDD−VCC)+VF2+Vbe) occurs between the points A and B, and an electric current, which flows through the power supply (VDD) of the power supply unit 27, the npn bipolar transistor 18 of the power supply unit 27, the primary side coil of the transformer 193, the MOSFET 19 of the power supply unit 26, and the ground of the power supply unit 26 in this order, flows through the power supply (VDD) of the power supply unit 27, the npn bipolar transistor 18 of the power supply unit 27, the primary side coil of the transformer 193, the diode 21 of the power supply unit 26, and the power supply (VDD) of the power supply unit 26 in this order. Accordingly, energy stored in the primary side coil of the transformer 193 is consumed by the diode 21 of the power supply unit 26, and the energy stored in the primary side coil of the transformer 193 is reset.

Here, assume that the voltage with the positive polarity ((VDD−VCC)+VF2+Vbe), which occurs between the points A and B at this time, is a voltage with a level by which a high-level voltage is not output from the comparator 202. Namely, the voltage with the positive polarity ((VDD−VCC)+VF2+Vbe) is assumed to be a voltage lower than the above described first threshold.

Accordingly, oscillation in the secondary side circuit 192 can be prevented after the rising or the falling timing of an input signal in the signal transfer circuit 70 shown in FIG. 13 even if the coupling coefficient of the transformer 193 is low. Therefore, a malfunction can be suppressed.

As described above, oscillation in the secondary side circuit 192 of the transformer 193 due to a low coupling coefficient of the transformer 193 can be prevented in the signal transfer circuits 1, 9, 14, 24, and 70 according to the first to the fifth embodiments. This eliminates the need to prevent the oscillation in the secondary side circuit 192 of the transformer 193 by decreasing the resistance value of the resistor 201, and the electric current, which flows through the signal transfer circuits 1, 9, 14 and 24, can be prevented from increasing.

Additionally, the above described signal transfer circuits 1, 9, 14, 24, and 70 respectively have a configuration where a digital signal is transferred from the primary side circuit to the secondary side circuit with the transformer 193. Therefore, these circuits have superior characteristics such as high reliability, high endurance, high speed, etc.

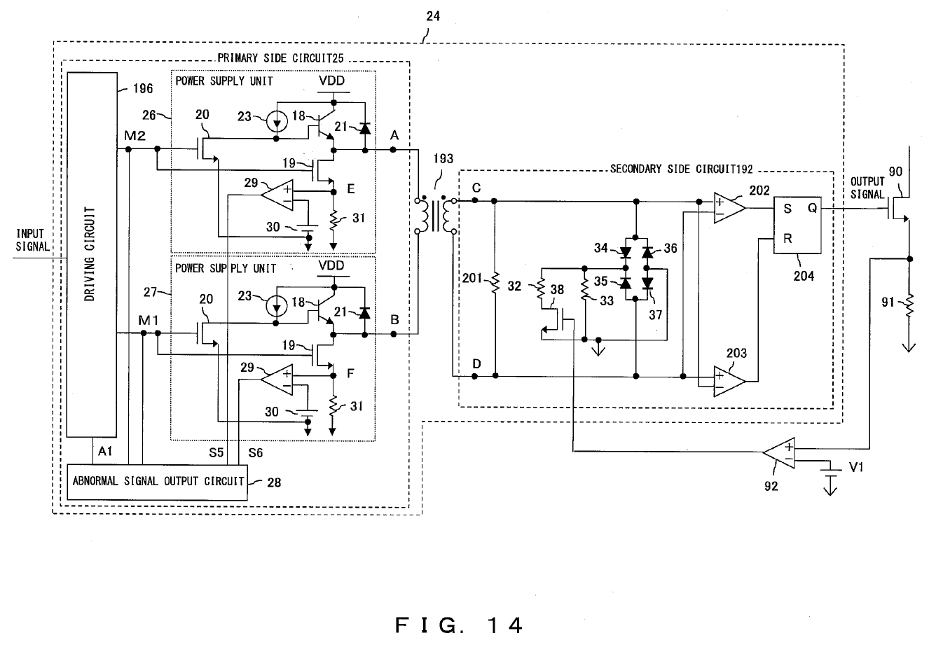

FIG. 14 shows a signal transfer circuit according to a sixth embodiment of the present invention. The same constituent elements as those of the signal transfer circuit shown in FIG. 11 are denoted with the same reference numerals, and their explanations are omitted.

In the embodiment shown in FIG. 14, an abnormal signal output circuit 28 is added in the primary side circuit 25. Additionally, a comparator 29, a constant-voltage source 30, and a resistor 31 are respectively added in the power supply units 26 and 27. Furthermore, resistors 32 and 33, diodes 34 to 37, and an n-channel MOSFET 38 are added in the secondary side circuit 192. Assume that an electric current increase circuit recited in claims is configured, for example, with the resistor 32 and the MOSFET 38. Also assume that the resistance value of the resistor 33 is larger than that of the resistor 32.

The collector terminal of an npn bipolar transistor 18 is connected to a power supply of a voltage VDD and the cathode terminal of a diode 21, and further connected to the drain terminal of a MOSFET 20 and the base terminal of the npn bipolar transistor 18 via a constant-current source 23, whereas the emitter terminal of the npn bipolar transistor 18 is connected to the drain terminal of a MOSFET 19 and the anode terminal of the diode 21. The gate terminals of the MOSFETs 19 and 20 are mutually connected, and the source terminal of the MOSFET 19 is connected to the positive input terminal of the comparator 29, and further connected to a ground via the resistor 31. The source terminal of the MOSFET 20 and the negative terminal of the constant-voltage source 30 are respectively connected to a ground. The negative input terminal of the comparator 29 is connected to the positive terminal of the constant-voltage source 30. A connection point between the npn bipolar transistor 18 and the MOSFET 19 in the power supply unit 26 is connected to one end of the primary side coil of the transformer 193, and a connection point between the npn bipolar transistor 18 and the MOSFET 19 in the power supply unit 27 is connected to the other end of the primary side coil of the transformer 193.

Here, assume that a connection point between the source terminal of the MOSFET 19 and the resistor 31 is a point E in the power supply unit 26, and a connection point between the source terminal of the MOSFET 19 and the resistor 31 is a point F in the power supply unit 27.

Also assume that the signal transfer circuit 24 shown in FIG. 14 outputs a output signal to the gate terminal of an n-channel MOSFET 90, and a voltage output from a comparator 92, where a voltage applied to a resistor 91 provided between the source terminal of the MOSFET 90 and a ground is input to the positive input terminal and a reference voltage V1 is input to the negative input terminal, is input to the gate terminal of the MOSFET 38.

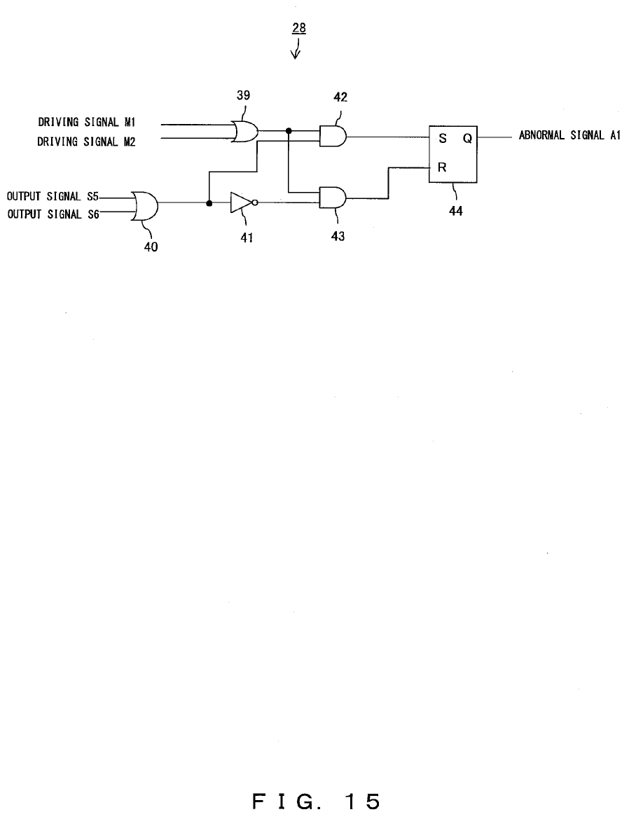

FIG. 15 shows the abnormal signal output circuit 28.

The abnormal signal output circuit 28 shown in FIG. 15 is configured by including OR circuits 39 and 40, an inverter 41, AND circuits 42 and 43, and a flip-flop circuit 44.

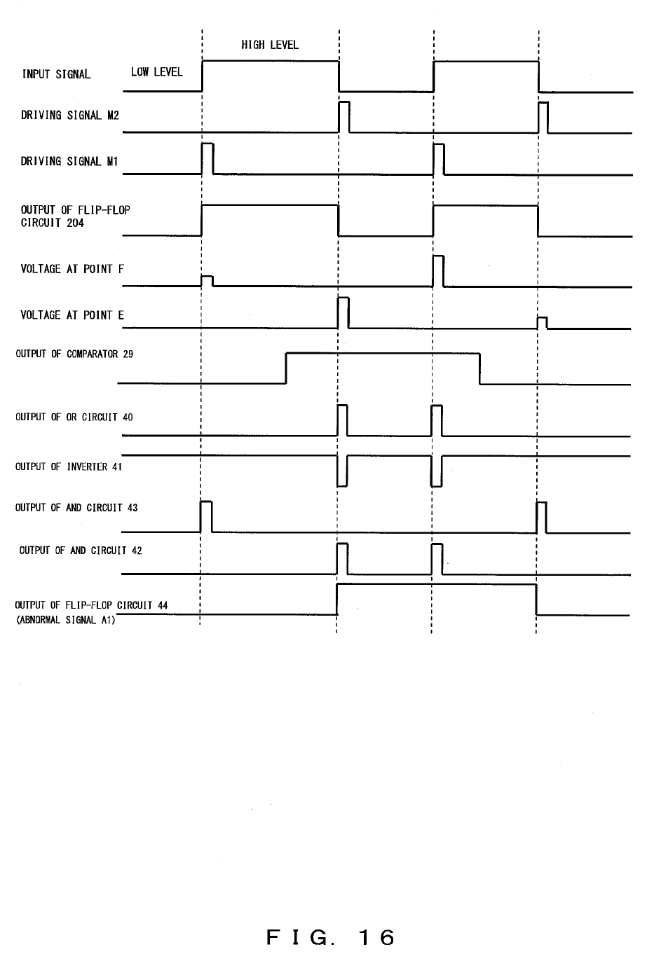

FIG. 16 is a timing chart showing the outputs of the circuits within the abnormal signal output circuit 28.

For example, if the MOSFET 90 is destroyed due to some cause, a high voltage is applied to the resistor 91, and the voltage output from the comparator 92 makes a transition to a high level, the MOSFET 38 is turned on. Then, the resistor 32 is enabled, and the electric current that flows through the secondary side circuit 192 increases. Therefore, also the electric current that flows through the primary side coil of the transformer 193 increases. If the input signal rises or falls at this time, the voltage at the point E or F in the primary side circuit 25 becomes higher than that at a normal time (when a low-level voltage is output from the comparator 92), a high-level pulse voltage (output signal S5 or S6) is output from the comparator 29 of the power supply unit 26 or 27, and a high-level pulse voltage is output from the AND circuit 42. Accordingly, a voltage (abnormal signal Al) output from the flip-flop circuit 44 makes a transition from a low level to a high level.

When the voltage output from the comparator 92 makes a transition to a low-level, for example, because a high voltage is not applied to the resistor 91 thereafter, the MOSFET 38 is turned off, and the resistor 32 is disabled. Therefore, the electric current that flows through the secondary side circuit 192 decreases, and also the electric current that flows through the primary side coil of the transformer 193 decreases. When the input signal rises or falls at this time, the voltage at the point E or F in the primary side circuit 25 decreases, and restores to the normal state. Then, the voltage (output signal S5 or S6) output from the comparator 29 of the power supply unit 26 or 27 makes a transition to a low-level, and a high-level pulse voltage is output from the AND circuit 43. Therefore, the voltage (abnormal signal A1) output from the flip-flop circuit 44 makes a transition from a high level to a low level.

As described above, in the signal transfer circuit 24 shown in FIG. 14, when an abnormality occurs in the destination circuit of the output signal and the MOSFET 38 is turned on, the high-level abnormal signal Al is output from the abnormal signal output circuit 28. The MOSFETs 19 and 20 of the respective power supply units 26 and 27 may be suspended, for example, if the high-level abnormal signal Al is output from the abnormal signal output circuit 28 to the driving circuit 196.

Additionally, the signal transfer circuit 24 shown in FIG. 14 can be prevented from malfunctioning even if the resistance value of the resistor 201 that is connected in parallel to the secondary side coil of the transformer 193 is increased (R201>R32). Accordingly, a large difference can be provided between the electric currents that flow through the secondary side circuit 192 in normal and abnormal cases, whereby the accuracy of the abnormal signal output circuit 28 can be improved.

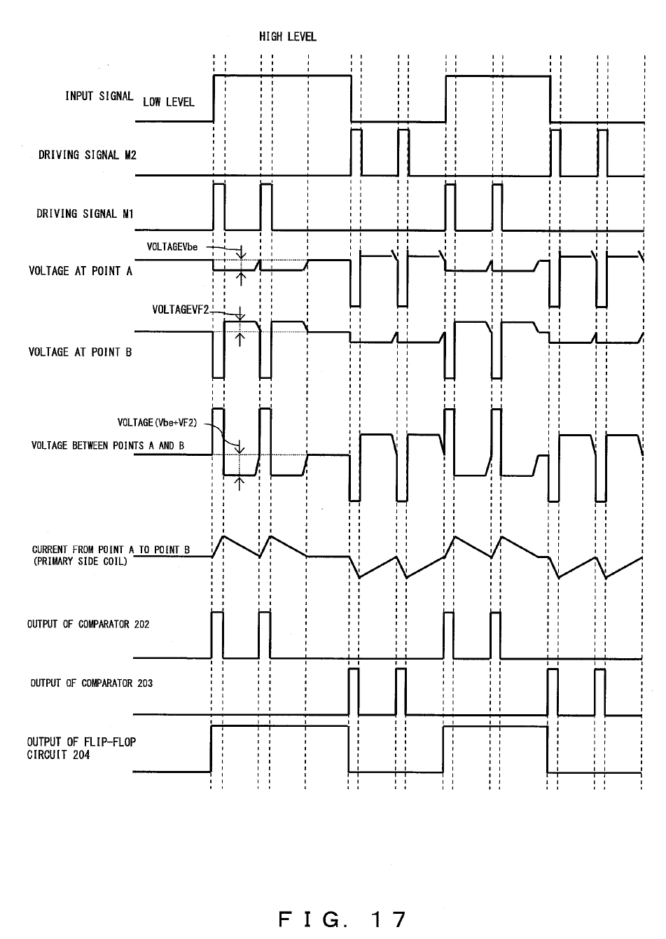

FIG. 17 is a timing chart showing the outputs of circuits within another implementation example of the signal transfer circuit 24 shown in FIG. 11. FIG. 17 depicts the case where the high-level and the low-level periods of an input signal are sufficiently longer than the pulse widths of the driving signals M1 and M2.

The timing chart showing the outputs of the circuits within the signal transfer circuit 24, which is shown in FIG. 17, is different from the timing chart showing the outputs of the circuits within the signal transfer circuit 24, which is shown in FIG. 12, in a point that a voltage (driving signal M2) of two high-level pulses that are successive in a predetermined time is output from the driving circuit 196 at the rising timing of an input signal, and a voltage (driving signal M1) of two high-level pulses that are successive in a predetermined time period is output from the driving circuit 196 at the falling timing of the input signal.

Here, assume that the predetermined time period is set to a time period equal to or longer than a time period required from when a pulse is output until when the electric current flowing through the primary side coil of the transformer 193 by the pulse is reduced to 0 by the pulse. Namely, the npn bipolar transistor 18, the diode 21, etc. are configured so that (VDD−Vbe)×(high-level period of the driving signal M1 (M2))−(VF2+Vbe)×(predetermined time period)>0 is satisfied.

When the MOSFETs 19 and 20 of the power supply unit 27 are driven with the voltage of two successive high-level pulses (driving signal M1) and the MOSFETs 19 and 20 of the power supply unit 26 are driven with the low-level voltage (driving signal M2) at the rising timing of the input signal as shown in FIG. 17, a voltage of two successive low-level pulses occurs at a point B, and a voltage of two successive pulses with a positive polarity occurs between the points A and B. With either of the two pulses with the positive polarity (the first pulse in FIG. 16), a high-level voltage is input from the comparator 202 to the set terminal (S) of the flip-flop circuit 204, and the voltage (output signal) output from the output terminal (Q) of the flip-flop circuit 204 increases.

In the meantime, when the MOSFETs 19 and 20 of the power supply unit 26 are driven with the voltage of two successive high-level pulses (driving signal M2) and the MOSFETs 19 and 20 of the power supply unit 27 are driven with the low-level voltage (driving signal M1) at the falling timing of the input signal, a voltage of two successive low-level pulses occurs at the point A, and a voltage of two successive pulses with a negative polarity occurs between the points A and B. With ether of the two pulses with the negative polarity (the first pulse in FIG. 17), a high-level voltage is input from the comparator 203 to the reset terminal (R) of the flip-flop circuit 204, and the voltage (output signal) output from the output terminal (Q) of the flip-flop circuit 204 decreases.

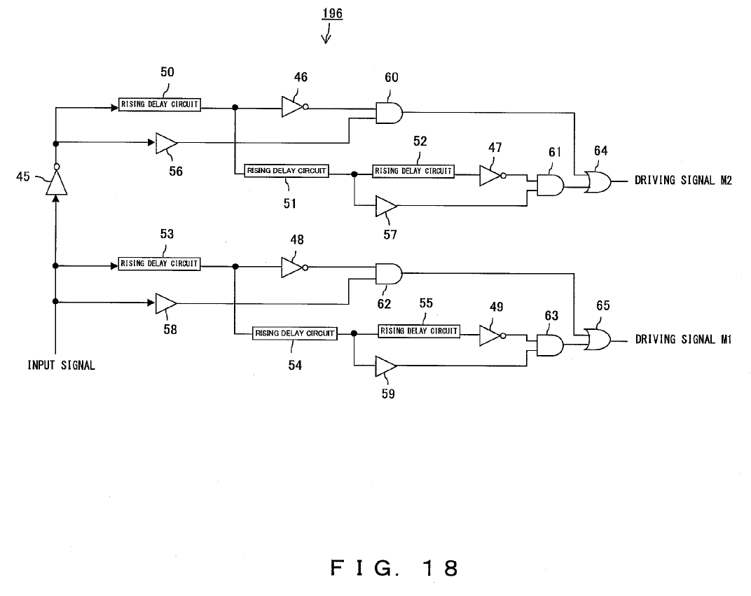

FIG. 18 shows the driving circuit 196 when the MOSFETs 19 and 20 of the respective power supply units 26 and 27 are driven with the voltage of two successive high-level pulses at the rising and the falling timings of the input signal.

The driving circuit 196 shown in FIG. 18 is configured by including inverters 45 to 49, rising delay circuits 50 to 55, buffers 56 to 59, AND circuits 60 to 63, and OR circuits 64 and 65.

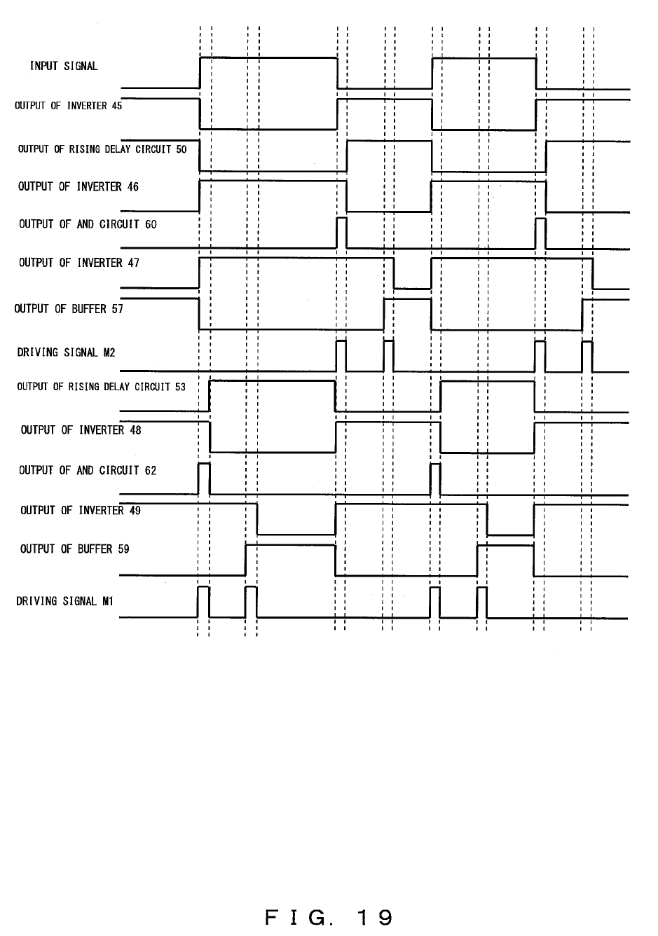

FIG. 19 is a timing chart showing the outputs of the circuits within the driving circuit 196 shown in FIG. 18. Here, assume that the delay times of the rising delay circuits 50, 52, 53, and 55 are the same, and the delay times of the rising delay circuits 51 and 54 are the same. Also assume the delay time of the rising delay circuit 50: the delay time of the rising delay circuit 51=(VDD−Vbe):(VF2+Vbe).

As shown in FIG. 19, an input signal at rising timing is input to one input terminal of the AND circuit 62 via the buffer 58, and at the same time, it is delayed by the rising delay circuit 53 by a predetermined time, inverted by the inverter 48, and input to the other input terminal of the AND circuit 62. As a result, a high-level pulse voltage is output as the driving signal M1 from the AND circuit 62 via the OR circuit 65. Additionally, the input signal at the rising timing is delayed by the rising delay circuits 53 and 54 by a predetermined time, and input to one input terminal of the AND circuit 63 via the buffer 59, and at the same time, it is delayed by the rising delay circuits 53 to 55 by a predetermined time, inverted by the inverter 49, and input to the other input terminal of the AND circuit 63. As a result, a high-level pulse voltage is output as the driving signal M1 from the AND circuit 63 via the OR circuit 65 after the high-level pulse voltage is output as the driving signal M1 from the AND circuit 62 via the OR circuit 65. The driving signal M1 output from the OR circuit 65 is respectively output to the gate terminals of the MOSFETs 19 and 20 of the power supply unit 27. At this time, a low-level voltage is output as the driving signal M2 from the OR circuit 64 to the gate terminals of the MOSFETs 19 and 20 of the power supply unit 26.

In the meantime, the input signal at the falling timing is inverted by the inverter 45, and input to one input terminal of the AND circuit 60 via the buffer 56, and at the same time, it is inverted by the inverter 45, delayed by the rising delay circuit 50 by a predetermined time, inverted by the inverter 46, and input to the other input terminal of the AND circuit 60. As a result, a high-level pulse voltage is output as the driving signal M2 from the AND circuit 60 via the OR circuit 64. Additionally, the input signal at the falling timing is inverted by the inverter 45, delayed by the rising delay circuits 50 and 51 by a predetermined time, and input to one input terminal of the AND circuit 61 via the buffer 57, and at the same time, it is inverted by the inverter 45, delayed by the rising delay circuits 50 to 52 by a predetermined time, inverted by the inverter 47, and input to the other input terminal of the AND circuit 61. As a result, a high-level pulse voltage is output as the driving signal M2 from the AND circuit 61 via the OR circuit 64 after the high-level pulse voltage is output as the driving signal M2 from the AND circuit 60 via the OR circuit 64. The driving signal M2 output from the OR circuit 64 is respectively output to the gate terminals of the MOSFETs 19 and 20 of the power supply unit 26. At this time, a low-level voltage is output as the driving signal M1 from the OR circuit 65 to the gate terminals of the MOSFETs 19 and 20 of the power supply unit 27.

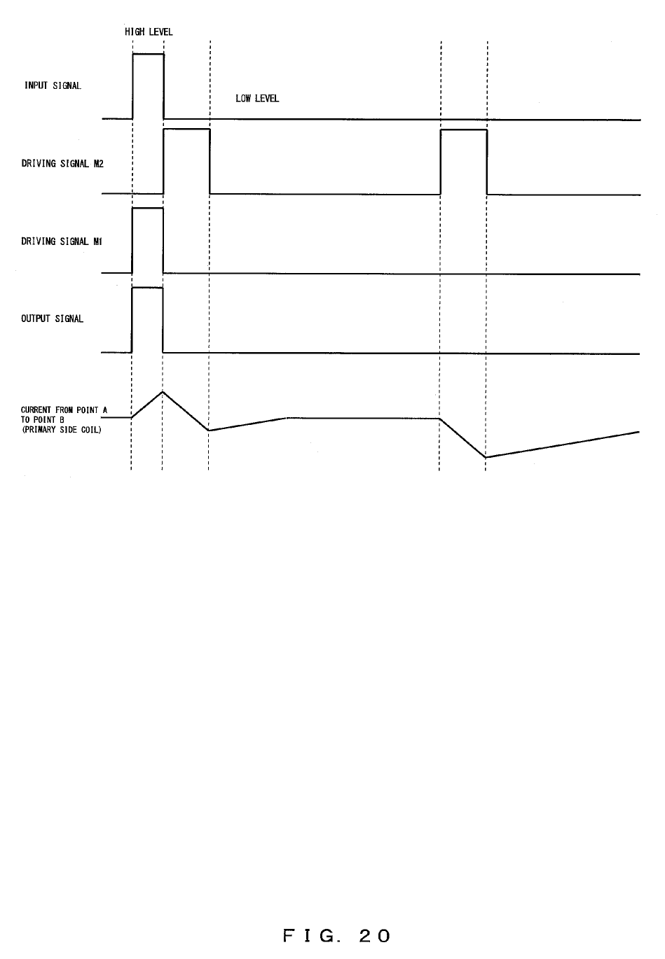

FIG. 20 is a timing chart showing the outputs of the circuits within the signal transfer circuit 24 when the high-level period of an input signal is shorter than the delay time of the rising delay circuit 53 in the case where the MOSFETs 19 and 20 of the signal transfer circuit 24 shown in FIG. 11 are driven with the driving signals M1 and M2 shown in FIG. 16.

As shown in FIG. 20, the electric current that is made to flow through the primary side coil of the transformer 193 by the first pulse of the driving signal M2 is reduced to 0 by the time the second pulse of the driving signal M2 is output, even if the high-level period of the input signal is shorter than the delay time of the rising delay circuit 53.

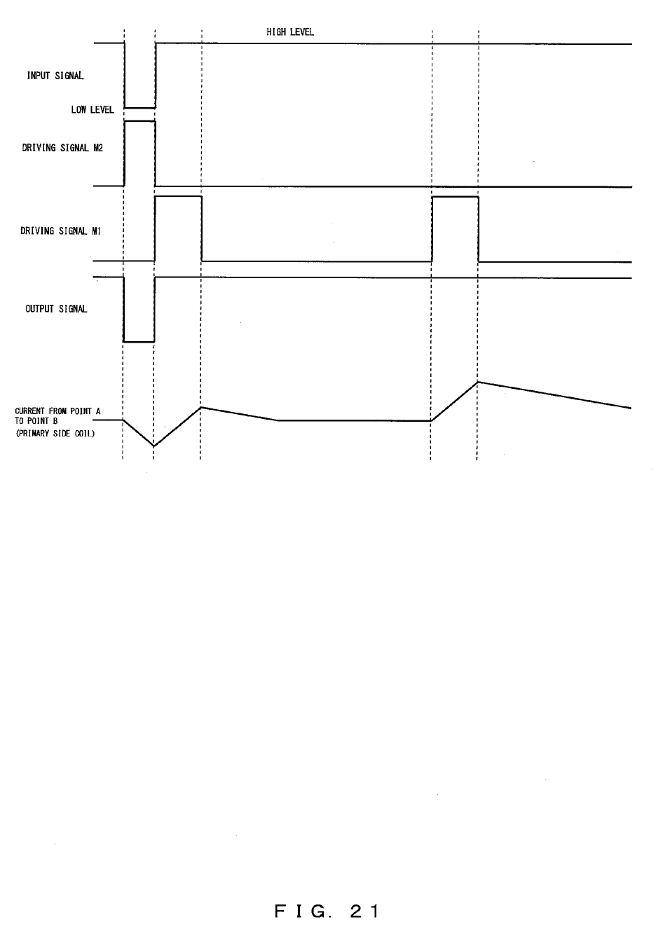

FIG. 21 is a timing chart showing the outputs of the circuits within the signal transfer circuit 24 when the low-level period of the input signal is shorter than the delay time of the rising delay circuit 50 in the case where the MOSFETs 19 and 20 of the signal transfer circuit 24 shown in FIG. 11 are driven with the driving signals M1 and M2 shown in FIG. 16.

As shown in FIG. 21, the electric current that is made to flow through the primary side coil of the transformer 193 by the first pulse of the driving signal M1 is reduced to be 0 by the time the second pulse of the driving signal M1 is output, even if the low-level period of the input signal is shorter than the delay time of the rising delay circuit 50.

As described above, the transfer accuracy of a digital signal can be improved by driving the MOSFETs 19 and 20 of the respective power supply units 26 and 27 with two successive high-level pulses at the rising and the falling timings of the input signal.

Additionally, since the second pulse is output after the electric current that is made to flow through the primary side coil of the transformer 193 by the first pulse is reduced to zero, the electric current that is made to flow through the primary side coil of the transformer 193 by the second pulse does not become higher than the electric current that is made to flow through the primary side coil of the transformer 193 by the first pulse. As a result, the electric current that flows through the secondary side coil of the transformer 193 can be reduced even if the MOSFETs 19 and 20 are driven with two successive pulses. Therefore, oscillation in the secondary side circuit 192 can be prevented.

The MOSFETs 19 and 20 of the respective power supply units 26 and 27 may be driven with a voltage of three or more successive high-level pulses at the rising and the falling timings of the input signal.

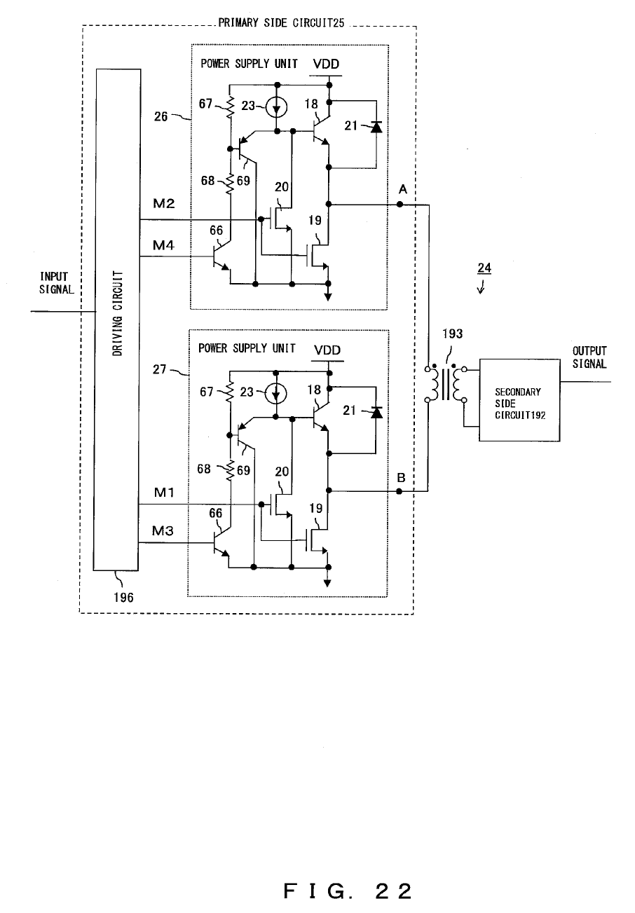

FIG. 22 shows another configuration of the power supply units 26 and 27 in the signal transfer circuit 24 shown in FIG. 11. The same constituent elements as those of the configuration shown in FIG. 11 are denoted with the same reference numerals, and their explanations are omitted.

The power supply units 26 and 27 shown in FIG. 22 are respectively configured by including npn bipolar transistors 18 and 66, MOSFETs 19 and 20, a diode 21, a constant-current source 23, resistors 67 and 68, and a pnp bipolar transistor 69.

The collector terminal of the npn bipolar transistor 18 is connected to the power supply of the voltage VDD and the cathode terminal of the diode 21, and further connected to the base terminal of the npn bipolar transistor 18, the emitter terminal of the pnp bipolar transistor 69, and the drain terminal of the MOSFET 20 via the constant-current source 23, whereas the emitter terminal of the npn bipolar transistor 18 is connected to the anode terminal of the diode 21 and the drain terminal of the MOSFET 19. The collector terminal of the npn bipolar transistor 66 is connected to the power supply of the voltage VDD via the resistors 67 and 68 that are connected in series, whereas the emitter terminal of the npn bipolar transistor 66 is connected to a ground. The base terminal of the pnp bipolar transistor 69 is connected to a connection point between the resistors 67 and 68, whereas the collector terminal of the pnp bipolar transistor 69 is connected to the ground. The gate terminals of the MOSFETs 19 and 20 are mutually connected, and the source terminals of the MOSFETs 19 and 20 are connected to the ground. A connection point between the npn bipolar transistor 18 and the MOSFET 19 in the power supply unit 26 is connected to one end of the primary side coil of the transformer 193, and a connection point between the npn bipolar transistor 18 and the MOSFET 19 in the power supply unit 27 is connected to the other end of the primary side coil of the transformer 193.

Assume that the driving circuit 196 shown in FIG. 22 outputs a driving signal M3 of a high-level pulse voltage to the npn bipolar transistor 66 of the power supply unit 27 after the respective pulses of the driving signal M1 shown in FIG. 17, and also outputs a driving signal M4 of a high-level pulse voltage to the npn bipolar transistor 66 of the power supply unit 26 after the respective pulses of the driving signal M2 shown in FIG. 17. Also assume that the resistance values of the resistors 67 and 68 are R3 and R4 respectively.

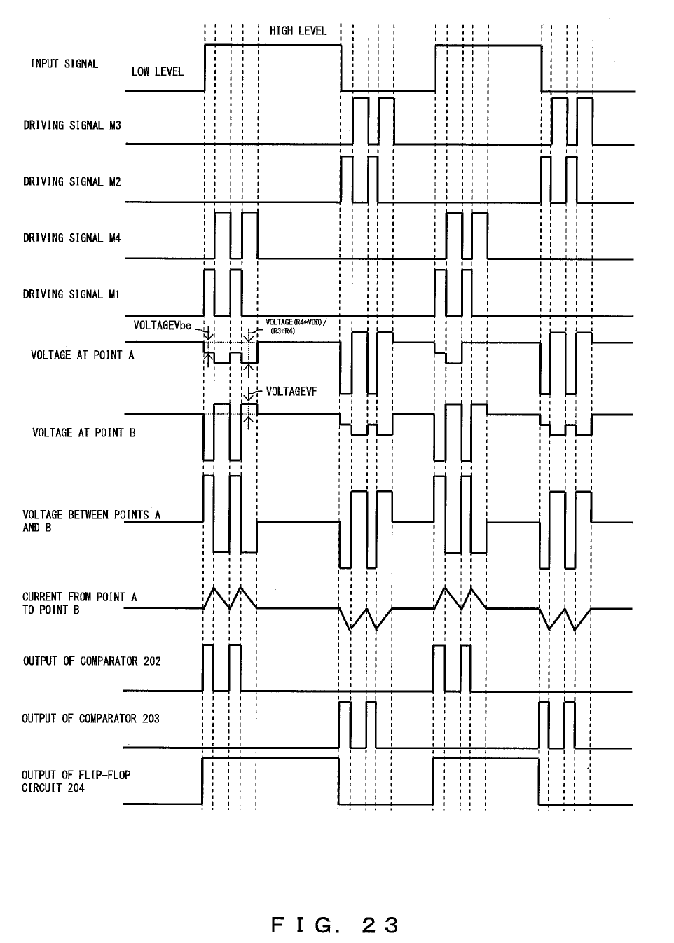

FIG. 23 is a timing chart showing the outputs of the circuits within the signal transfer circuit 24 including the power supply units 26 and 27 shown in FIG. 22.

As shown in FIG. 23, the first high-level pulse of the driving signal M1 is respectively input to the gate terminals of the MOSFETs 19 and 20 of the power supply unit 27 at the rising timing of the input signal (at this time, the driving signal M2 input to the gate terminals of the MOSFETs 19 and 20 of the power supply unit 26, the driving signal M3 input to the gate terminal of the npn bipolar transistor 66 of the power supply unit 27, and the driving signal M4 input to the gate terminal of the npn bipolar transistor 66 of the power supply unit 26 are low-level).

Then, a point B is connected to the ground, and a voltage at the point A results in a voltage (VDD−Vbe) that drops from VDD by a voltage Vbe that is the voltage between the base and the emitter of the npn bipolar transistor 18. Therefore, a voltage with a positive polarity (VDD−Vbe) occurs between the points A and B. As a result, the voltage output from the comparator 202 to the set terminal (S) of the flip-flop circuit 204 makes a transition from a low level to a high level, and a voltage (output signal) output from the output terminal (Q) of the flip-flop circuit 204 increases.

In the meantime, the first high-level pulse of the driving signal M2 is respectively input to the gate terminals of the MOSFETs 19 and 20 of the power supply unit 26 at the falling timing of the input signal (at this time, the driving signal M1 respectively input to the gate terminals of the MOSFETs 19 and 20 of the power supply unit 27, the driving signal M3 input to the gate terminal of the npn bipolar transistor 66 of the power supply unit 27, and the driving signal M4 input to the gate terminal of the npn bipolar transistor 66 of the power supply unit 26 are low-level).

Then, the point A is connected to the ground, and the voltage at the point B results in a voltage (VDD−Vbe) that drops from VDD by the voltage Vbe that is the voltage between the base and the emitter of the npn bipolar transistor 18. Therefore, a voltage with a negative polarity (−(VDD−Vbe)) occurs between the points A and B. As a result, the voltage output from the comparator 203 to the reset terminal (R) of the flip-flop circuit 204 makes a transition from a low level to a high level, and the voltage (output signal) output from the output terminal (Q) of the flip-flop circuit 204 decreases.

As described above, an output signal the rising and the falling timings of which are the same as those of an input signal can be output via the transformer 193 also in the signal transfer circuit 24 including the power supply units 26 and 27 shown in FIG. 22.

After the rising timing of the input signal, the driving signal M1 restores from the high level to the low level, and the driving signal M4 makes a transition from a low level to a high level in the signal transfer circuit according to this embodiment.

Then, the npn bipolar transistor 66 of the power supply unit 26 and the npn bipolar transistor 18 of the power supply unit 27 are turned on, and the MOSFET 19 of the power supply unit 27 is turned off. As a result, a voltage with a negative polarity (−(R4×VDD)/(R3+R4)+VF2)) occurs between the points A and B, and an electric current, which flows through the power supply (VDD) of the power supply unit 26, the npn bipolar transistor 18 of the power supply unit 26, the primary side coil of the transformer 193, the MOSFET 19 of the power supply unit 27, and the ground of the power supply unit 27 in this order, flows through the power supply (VDD) of the power supply unit 26, the npn bipolar transistor 18 of the power supply unit 26, the primary side coil of the transformer 193, the diode 21 of the power supply unit 27, and the power supply (VDD) of the power supply unit 27 in this order. Accordingly, energy stored in the primary side coil of the transformer 193 is consumed by the diode 21 of the power supply unit 27, and the transformer 193 is reset.

After the falling timing of the input signal, the driving signal M2 restores from the high level to the low level, and the driving signal M3 makes a transition from a low level to a high level in the signal transfer circuit according to this embodiment.

Then, the npn bipolar transistor 66 of the power supply unit 27 and the npn bipolar transistor 18 of the power supply unit 26 are turned on, and the MOSFET 19 of the power supply unit 26 is turned off. As a result, a voltage with a positive polarity ((R4'VDD)/(R3+R4)+VF2) occurs between the points A and B, and an electric current, which flows through the power supply (VDD) of the power supply unit 27, the npn bipolar transistor 18 of the power supply unit 27, the primary side coil of the transformer 193, the MOSFET 19 of the power supply unit 26, and the ground of the power supply unit 26 in this order, flows through the power supply (VDD) of the power supply unit 27, the npn bipolar transistor 18 of the power supply unit 27, the primary side coil of the transformer 193, the diode 21 of the power supply unit 26, and the power supply (VDD) of the power supply unit 26 in this order. Accordingly, energy stored in the primary side coil of the transformer 193 is consumed by the diode 21 of the power supply unit 26, and the transformer 193 is reset.

Namely, the npn bipolar transistor 18, the diode 21, the resistors 67 and 68, and the like are configured so that (VDD−Vbe)×(high-level period of the driving signal M1 (M2)−((R4×VDD)/(R3+R4)+VF2)×(predetermined time period)≧0 is satisfied.

As described above, oscillation in the secondary side circuit can be prevented after the rising and the falling timings of an input signal also in the signal transfer circuit 24 including the power supply units 26 and 27 shown in FIG. 22. Therefore, a malfunction can be suppressed.

Additionally, the value of a voltage with a positive or negative polarity, which occurs between the points A and B of the primary side coil when the npn bipolar transistor 66 is turned on, can be adjusted by adjusting the resistance values of the resistors 67 and 68 of the power supply units 26 and 27. For example, by making the resistance value of the resistor 67 of the power supply units 26 and 27 sufficiently larger than the resistance value of the resistor 68 of the power supply units 26 and 27, the voltage with the positive or negative polarity, which occurs between the points A and B of the primary side coil when the npn bipolar transistor 66 is turned on, can be further increased. Accordingly, the electric current that flows through the primary side coil of the transformer 193 can be restored to 0 more quickly with the first pulse of the driving signals M1 and M2. Therefore, the signal transfer circuit 24 including the power supply units 26 and 27 shown in FIG. 22 is effective when the MOSFETs 19 and 20 are driven with a plurality of successive pulses. Namely, the signal transfer circuit 24 including the power supply units 26 and 27 shown in FIG. 22 can be prevented from malfunctioning while increasing the transfer accuracy of a digital signal.

The secondary side circuit according to this embodiment includes the comparators and the flip-flop circuit. However, the configuration of the secondary side circuit is not limited to this one as far as the output signal can be made to rise by applying a voltage with a predetermined polarity to the secondary side coil of the transformer, and the output signal can be made to fall by applying a voltage with the polarity opposite to the predetermined polarity to the secondary side coil of the transformer. For example, the secondary side circuit may be configured so that hysteresis comparators where its positive and negative input terminals are connected to the points C and D respectively are included as a replacement for the comparators and the flip-flop circuit, and signals output from the output terminals of the hysteresis comparators are obtained.

Furthermore, in the above described embodiments, the energy stored in the primary side coil is consumed by the voltage applying means connected to the power supply voltage VDD after the rising or the falling timing of the input signal. However, the energy stored in the primary side coil may be consumed by the voltage applying means connected to the ground.

What is claimed:

1. A signal transfer circuit, comprising:
a transformer having a primary side coil and a secondary side coil;
a plurality of switching elements provided between a power supply and a ground;
a driving circuit for causing a voltage with a first polarity to be generated in the primary side coil by respectively controlling the plurality of switching elements at rising timing of an input signal, and for causing a voltage with a second polarity opposite to the first polarity to be generated in the primary side coil by respectively controlling the plurality of switching elements at falling timing of the input signal; and
a secondary side circuit for causing an output signal to rise when the voltage with the first polarity, which is equal to or higher than a first threshold, is generated in the secondary side coil, and for causing the output signal to fall when the voltage with the second polarity, which is equal to or higher than a second threshold, is generated in the secondary side coil, wherein
the driving circuit controls the plurality of switching elements so that a voltage for generating the voltage with the second polarity, which is lower than the second threshold, in the secondary side coil is generated in the primary side coil after the voltage with the first polarity, which is equal to or higher than the first threshold, is generated in the secondary side coil, and controls the plurality of switching elements so that a voltage for generating the voltage with the first polarity, which is lower than the first threshold, in the secondary side coil is generated in the primary side coil after the voltage with the second polarity, which is equal to or higher than the second threshold, is generated in the primary side coil.

2. The signal transfer circuit according to claim 1, comprising:
a voltage applying means provided between one end of the primary side coil and the power supply, and between the other end of the primary side coil and the power supply, wherein:
the plurality of switching elements are composed of first to fourth switching elements;
one end of the primary side coil is connected to the power supply via the first switching element and further connected to the ground via the second switching element, and the other end of the primary side coil is connected to the power supply via the third switching element and further connected to the ground via the fourth switching element;
the driving circuit causes the voltage for generating the voltage with the first polarity, which is equal to or higher than the first threshold, in the secondary side coil to be generated in the primary side coil by controlling the plurality of switching elements so that the first switching element and the fourth switching element are turned on, and the second switching element and the third switching element are turned off;
the driving circuit causes the voltage for generating the voltage with the second polarity, which is equal to or higher than the second threshold, in the secondary side coil to be generated in the primary side coil by controlling the plurality of switching elements so that the second switching element and the third switching element are turned on, and the first switching element and the fourth switching element are turned off;
the driving circuit causes an electric current flowing through the primary side coil to flow to the power supply via the voltage applying means, and also causes the voltage for generating the voltage with the second polarity, which is lower than the second threshold, in the secondary side coil to be generated in the primary side coil by controlling the plurality of switching elements so that the first switching element and the third switching element are turned on, and the second switching element and the fourth switching element are turned off, after the voltage with the first polarity, which is equal to or higher than the first threshold, is generated in the secondary side coil; and
the driving circuit causes the electric current flowing through the primary side coil to flow to the power supply via the voltage applying means, and also causes the voltage for generating the voltage with the first polarity, which is lower than the first threshold, in the secondary side coil to be generated in the primary side coil by controlling the plurality of switching elements so that the first switching element and the third switching element are turned on, and the second switching element and the fourth switching element are turned off, after the voltage with the second polarity, which is equal to or higher than the second threshold, is generated in the secondary side coil.

3. The signal transfer circuit according to claim 1, comprising:
a voltage applying means provided between one end of the primary side coil and the ground, and between the other end of the primary side coil and the ground, wherein:
the plurality of switching elements are composed of first to fourth switching elements;
one end of the primary side coil is connected to the power supply via the first switching element and further connected to the ground via the second switching element, and the other end of the primary side coil is connected to the power supply via the third switching element and further connected to the ground via the fourth switching element;
the driving circuit causes the voltage for generating the voltage with the first polarity, which is equal to or higher than the first threshold, in the secondary side coil to be generated in the primary side coil by controlling the plurality of switching elements so that the first switching element and the fourth switching element are turned on, and the second switching element and the third switching element are turned off;
the driving circuit causes the voltage for generating the voltage with the second polarity, which is equal to or higher than the second threshold, in the secondary side coil to be generated in the primary side coil by controlling the plurality of switching elements so that the second switching element and the third switching element are turned on, and the first switching element and the fourth switching element are turned off;
the driving circuit causes an electric current flowing through the primary side coil to flow to the ground, and also causes the voltage for generating the voltage with the second polarity, which is lower than the second threshold, in the secondary side coil to be generated in the primary side coil by controlling the plurality of switching elements so that the second switching element and the fourth switching element are turned on, and the first switching element and the third switching element are turned off, after the voltage with the first polarity, which is equal to or higher than the first threshold, is generated in the secondary side coil; and
the driving circuit causes the electric current flowing through the primary side coil to flow to the ground, and also causes the voltage for generating the voltage with the first polarity, which is lower than the first threshold, in the secondary side coil to be generated in the primary side coil by controlling the plurality of switching elements so that the second switching element and the fourth switching element are turned on, and the first switching element and the third switching element are turned off, after the voltage with the second polarity, which is equal to or higher than the second threshold, is generated in the secondary side coil.

4. The signal transfer circuit according to claim 1, wherein the voltage applying means is configured with at least one of a resistor, a diode, and a transistor.

5. The signal transfer circuit according to claim 1, further comprising:
a current increase circuit for increasing an electric current flowing through the secondary side coil when an abnormality occurs in an output destination of the output signal; and
an abnormal signal output circuit for outputting to the driving circuit an abnormal signal for notifying that the abnormality occurs in the output destination, if the electric current flowing through the primary side coil increases with an increase in the electric current flowing through the secondary side coil.

6. The signal transfer circuit according to claim 5, wherein the driving circuit controls the plurality of switching elements so that the voltage with the first polarity, which is equal to or higher than the first threshold, is generated in the secondary side coil after a predetermined time elapses from when the voltage with the second polarity, which is lower than the second threshold, is generated in the secondary side coil.

7. The signal transfer circuit according to claim 5, wherein the driving circuit controls the plurality of switching elements so that the voltage with the second polarity, which is equal to or higher than the second threshold, is generated in the secondary side coil after a predetermined time elapses from when the voltage with the first polarity, which is lower than the first threshold, is generated in the secondary side coil.

8. The signal transfer circuit according to claim 6, wherein the predetermined time is a time equal to or longer than a time required from when the voltage with the first polarity, which is lower than the first threshold, or the voltage with the second polarity, which is lower than the second threshold, is generated in the secondary side coil until when the electric current flowing through the primary side coil is reduced to 0.

9. The signal transfer circuit according to claim 7, wherein the predetermined time is a time equal to or longer than a time required from when the voltage with the first polarity, which is lower than the first threshold, or the voltage with the second polarity, which is lower than the second threshold, is generated in the secondary side coil until when the electric current flowing through the primary side coil is reduced to 0.
